(19) United States
(12) Patent Application Publication
(10) Pub. No.: US 2009/0313045 A1
(43) Pub. Date: Dec. 17, 2009

(54) System and Method for Medical Research and Clinical Trial

(76) Inventor: Mark D. Boyce, Lake Forest, IL (US)

Correspondence Address: DIEHL SERVILLA LLC, 77 BRANT AVE, SUITE 210, CLARK, NJ, 07066, US

(21) Appl. No.: 12/137,036

(22) Filed: Jun. 11, 2008

(51) Int. Cl. G06Q 50/00; G06N 5/00

(52) U.S. Cl. 705/3; 706/45

(57) ABSTRACT

A system and methods for a network for medical research and clinical trials are provided. Methods and systems for setting-up a clinical trial have been disclosed. Methods and system for identifying and qualifying participants in a trial have also been disclosed. Methods and systems for the automatic collection, extraction, distribution and review of data are also provided. Integration of a healthcare transcription platform with a clinical trial system is also disclosed.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The present invention relates to a network for medical research and clinical trial. More particularly, the present invention relates to improved targeting of participants, capturing of patient data and better distribution and processing of patient data through a network for medical research and clinical trial.

The Medical Research and Clinical Trial process in the US is a costly, haphazard, paper intensive and inefficient process. It relies on spending substantial amounts of time and money to find and attract qualified candidates for research or trials and then somehow collect all the information able to be found from a group of people that may range from small to very large. The information collected most often is limited to a particular provider's impressions of a patient and does not usually encompass the whole medical history of a particular patient—before, during or after the trial. The time involved for all parties is substantial; the methods require duplicate paperwork and the sample sizes of participants are small because of the difficulty in first finding and then capturing all the requisite information on the subjects. The result is a less than perfect process and information in the all important race to find answers, help and cures for today's most critical medical problems.

A system that uses a network to connect participants in a clinical trial or medical research and that applies methods that simplify and streamline the process, open the research and trial area to greater numbers of providers and patients, collect more and more detailed information, eliminate duplicate effort, shorten the process, speed the delivery of information and provide for better analysis through the digital rather than paper delivery of information does currently not exist.

Accordingly, novel and improved methods and systems and networks for capturing and processing of patient data in medical research and clinical trials are required.

### SUMMARY OF THE INVENTION

One aspect of the present invention presents a novel method and system for a network for medical research and clinical trial that will provide better access to participants and improved access to and processing of research data, including targeting and qualifying of participants in a clinical trial, automatically collecting of clinical trial data and extracting the right information from the collected data.

In accordance with a further aspect of the present invention, a method for conducting a clinical trial by using one or more rules which can be executed by a computing device for processing a set of clinical data of a patient is provided, comprising engaging with a healthcare provider for making a set of data of the patient available on-line on an Internet, identifying the patient as a potential participant by executing an identifying rule on the computing device, and qualifying the patient as a participant by executing a qualifying rule on the computing device.

In accordance with yet a further aspect of the present invention, a method for conducting a clinical trial is provided, further comprising setting up the identifying rule in the computing device for identifying the patient as a potential participant from the set of data of the patient including applying one or more identifying parameters relevant to the clinical trial and setting up the qualifying rule in the computing device including applying one or more qualifying parameters relevant to the clinical trial.

In accordance with yet a further aspect of the present invention, a method for conducting a clinical trial is provided, wherein the set of clinical data of the patient is provided by a medical transcription platform.

In accordance with yet a further aspect of the present invention, a method for conducting a clinical trial is provided, further comprising setting-up of a collection rule for collecting in a computing device of the set of clinical data during the clinical trial.

In accordance with yet a further aspect of the present invention, a method for conducting a clinical trial is provided, further comprising automatically collecting of the set of clinical data via the Internet in accordance with the collection rule.

In accordance with yet a further aspect of the present invention, a method for conducting a clinical trial is provided, further comprising setting up of an extraction rule in a computing device for extracting of a set of extracted data from the set of clinical data.

In accordance with yet a further aspect of the present invention, a method for conducting a clinical trial is provided, further comprising automatically extracting of the set of extracted data from the set of clinical data in accordance with the extraction rule.

In accordance with yet a further aspect of the present invention, a method for conducting a clinical trial is provided, further comprising setting up of a distribution rule in a computing device for distributing of the set of extracted data to one or more predetermined recipients.

In accordance with yet a further aspect of the present invention, a method for conducting a clinical trial is provided, further comprising automatically distributing the set of extracted data extracted in accordance with the distribution rule.

In accordance with another aspect of the present invention, a system for conducting a clinical trial is provided, comprising a memory, the memory enabled to store and provide data, a processor, the processor enabled to execute instructions retrieved from the memory to perform the steps of: accessing a set of data of a patient via a network, identifying the patient from the set of data of the patient as a potential participant by executing an identifying rule, and qualifying the patient as a participant in the clinical trial by executing a qualifying rule.

In accordance with yet another aspect of the present invention, a system for conducting a clinical trial is provided, wherein the network is an Internet.

In accordance with yet another aspect of the present invention, a system for conducting a clinical trial is provided, wherein the set of data of the patient is provided by a Scribe platform.

In accordance with yet another aspect of the present invention, a system for conducting a clinical trial is provided, further comprising the steps of receiving and storing the identifying rule including one or more identifying parameters relevant to the clinical trial and receiving and storing the qualifying rule including one or more qualifying parameters relevant to the clinical trial.

In accordance with yet another aspect of the present invention, a system for conducting a clinical trial is provided, further comprising the steps of receiving and storing of a collection rule for collecting over a network of a set of clinical data of the patient after being qualified related to the clinical trial.

In accordance with yet another aspect of the present invention, a system for conducting a clinical trial is provided, further comprising a step of automatically collecting of the set of clinical data of the patient via the network in accordance with the collection rule.

In accordance with yet another aspect of the present invention, a system for conducting a clinical trial is provided, further comprising the steps of receiving and storing of an extraction rule for extracting of a set of extracted data from the set of clinical data of the patient collected via the network.

In accordance with yet another aspect of the present invention, a system for conducting a clinical trial is provided, further comprising a step of automatically extracting the set of extracted data from the set of clinical data of the patient collected via the network in accordance with the extraction rule.

In accordance with yet another aspect of the present invention, a system for conducting a clinical trial is provided, further comprising the steps of receiving and storing of a distribution rule for distributing via a network of the set of extracted data to one or more predetermined recipients.

In accordance with yet another aspect of the present invention, a system for conducting a clinical trial is provided, further comprising a step of automatically distributing the set of extracted data via the network to one or more predetermined recipients in accordance with the distribution rule.

In accordance with yet another aspect of the present invention, a system for conducting a clinical trial is provided, wherein the set of data of the patient is made available by a healthcare provider.

### DESCRIPTION OF THE DRAWINGS

FIG. 1 provides a diagram of a system for clinical trial and medical research in accordance with one aspect of the present invention including a setup process;

FIG. 2 illustrates a series of steps for network setup performed in accordance with an aspect of the present invention, including a targeting process;

FIG. 3 illustrates a series of steps for participant qualification performed in accordance with an aspect of the present invention;

FIG. 4 illustrates a series of steps for information collection, extraction and distribution performed in accordance with an aspect of the present invention;

FIG. 5 illustrates activities that can be performed by a member in a network in accordance with an aspect of the present invention;

FIG. 6 illustrates activities that can be performed by a healthcare provider in a network in accordance with an aspect of the present invention;

FIG. 7 illustrates activities that can be performed by a participant in a network in accordance with an aspect of the present invention;

FIG. 8 illustrates activities that can be performed on the Scribe transcription platform;

FIG. 9 is a diagram of a system in accordance with an aspect of the present invention;

FIGS. 10-31 provide user interfaces in accordance with one or more aspects of the present invention;

FIG. 32 provides an overview of a Network Member Web Site;

FIG. 33 provides an overview of a Provider Web Site;

FIG. 34 provides an overview of a Participant Web Site;

FIG. 35 provides a diagram of a trial network in accordance with an aspect of the present invention; and

FIG. 36 provides a diagram of a trial network in accordance with another aspect of the present invention.

### DESCRIPTION OF A PREFERRED EMBODIMENT

There are several base components to the system and methods for the network of medical research and clinical trial that are aspects of the present invention. Each component works in tandem with the others and with an underlying tracking system component to provide a complete system. Each component is available to be used with a variety of healthcare systems, for instance, through an open web service API, a series of web sites, standard HL7 interfaces, email, FTP, and phone. It may also be tightly integrated with the existing Scribe series of clinical information systems of which a description is provided below. Several components of a system will be described below.

### Trial Network Setup

A challenging problem that many researchers currently face in conducting a clinical trial or medical research is finding appropriate participants in sufficient numbers. An appropriate participant for a clinical trial or for medical research usually has to meet specific requirements that may be articulated in a profile. The profile depends on the kind of research or clinical trial. Among clinical trials there are several approaches which may include but are not limited to: (1) a treatment trial test that investigates the effects of for instance: a drug, combinations of drugs, or approaches to surgery or radiation therapy; (2) prevention trials that look for ways to prevent a disease in people who for instance have never had the disease or to prevent a disease from returning; (3) a diagnostic trial that is conducted to find a test for diagnosing a particular disease. Other clinical trials may also be conducted. Furthermore, clinical trials may be conducted for example for drugs which are in different stages of their life cycle. These trials thus may be a Pilot Study, a Phase I Study, a Phase II Study, a Phase III Study or a Phase IV Study. Each trial has its own demand for number of participants, profiles as well as duration. It should be clear that for the hundreds if not thousands of clinical trials going on in for instance this country establishing a group of appropriate qualified and willing participants for the duration of a clinical trial can be quite a challenge.

Different ways are currently applied by research organizations to create a base group of potential participants for clinical trials. One way is to advertise, for instance, in a newspaper to solicit participation from volunteers. Another way is by research institutions to create a group of volunteers who sign up for potential participation in medical research or a clinical trial. It should be clear that creating and qualifying a pool of participants in clinical research or trials can become quite a cumbersome effort.

As an aspect of the present invention, a structured method is provided to create a pool of participants that can be easily qualified and approached for participating in a research project such as medical research or a clinical trial. One underlying concept in setting up of the Trial Network is that the information to be entered in a database for potential participants should have the data and profiles that are relevant to selecting a participant for a trial. Furthermore, it is clear to the inventor that one set of data that would be very well geared towards selecting a participant for a trial would be medical or clinical data about a patient that is available from a medical practitioner or what be called herein a healthcare provider. For instance, a healthcare provider may provide a broad range of health services by different practitioners within one organization, and may include, but is not limited to internal medicine, cardiology, allergy & immunology; dermatology, neurology and other medical disciplines. Many healthcare providers now consolidate medical records of a patient into a single accessible database. Accordingly, having access to a database provided by a healthcare provider would be beneficial to selecting a participant in a trial or a project. Consolidating the availability of these records for targeting in a network for medical research and clinical trials is therefore a novel approach to solving the problem of matching patients/participants to research and trials.

In one embodiment, one may process the records of a patient as soon as a patient is signed up as a future or potential participant of a clinical trial or medical research. In a further embodiment, one may extract participant patient data. Clearly, not all data in a patient record may be relevant to select a patient to invite him/her to participate in a clinical trial. Some data may also be time dependent. Accordingly, it may be beneficial to extract data and put it in a format that can be searched rapidly. For instance, one may create data base fields with recent vitals, illnesses, family history, age, type of work, gender, and other fields. In a further embodiment, one may provide certain codes to those fields. One may then attach the extracted data of patients, who are now part of a clinical trial network in a separate document of database that is part of the patient's record. This may allow an initial targeting by a network member to take place very rapidly as only structured data has to be searched. One may also put the extracted data in a database that is for instance dedicated to a Trial Network. In general, a healthcare provider may want to manage and control such a database.

In one embodiment, a network member can create an arrangement with one or more healthcare providers and its patients to access patient data to identify potential participants in a clinical trial or medical research. The patient data may be stored on a computing device. It may, for instance, be stored on a database. Data stored on a computing device or on a database may be accessible to a network member via a network to identify or target participants in a clinical trial or medical research. Data relevant to a medical trial may be organized in such a way and made accessible that it is easier to access and to process by a network member. In a further embodiment, a computer application or program may be applied to extract data relevant to a project of a network member or organize it in a database that is accessible for processing by a network member. Clearly, a database of patient data may be a dynamic entity with additions, changes and removals being applied. In a further embodiment, a computer application may be applied that extracts, organizes or updates patient data accessible to a network member on a regular basis. Even if such patients are not engaged in a trial or in research but are available as potential participants, such a program may run on an intermittent or on a continuous basis. In a continuous basis, it may extract relevant data soon after new data after is entered. It may also run during office hours or during off-office hours, or during any time that allows updating of a database or reorganizing of data.

A network member thus may create at least one, and possibly several, databases of updated data of patients who themselves or their healthcare providers which may include clinics, physicians, hospitals, insurance companies or any organization that has access to and may aggregate relevant patient data who have expressed (a) an interest to potentially participate in a clinical trial or medical research and (b) are willing to make patient data available.

A network member thus may create a network of one or more databases with patient data that is regularly updated and that is available for targeting patients for participating in a clinical trial or medical research.

There may be several network members who will create and maintain their networks of accessible databases of potential research or trial candidates. These network members may, for instance, operate in different geographical areas. In one embodiment, a network member may be affiliated with a hospital group. A network member may also be an insurance provider. A network member may be a contractor which conducts clinical trials. A network member may be a research organization. A network member may be any institution or organization that has access to patient data. In a further embodiment, a network member may provide access to its network of candidate data to another party. Such sharing of networks may be beneficial in creating an adequate pool of participants for a clinical trial.

A network member may create and/or manage its network of potential clinical trial candidates. In yet a further embodiment, an organization may engage with a managing member to create, manage and maintain a network of potential clinical trial candidates. Such a managing member may apply a common set of tools, applications and rules designs and methods in accordance with one or more aspects of the present invention for one or more different networks of one or more different members. A managing member may create, maintain, manage and/or use a network as a contractor. As a contractor, a managing member may offer access by a network member to one or more networks. This may allow easy sharing and processing of data over different networks and may allow to aggregate sufficiently large pools of potential participants over different geographies. This facilitates the ability to quickly ramp up a research project with sufficient participants meeting specific requirements. It thus lowers barriers for conducting medical trials and research.

It should be clear that merely having access to one or more databases of potential participants in a project may have limited use if one cannot narrow the potential candidates to participants that would fit a certain profile. The Trial Network Setup component as an aspect of the present invention provides the methods by which those running clinical trials or interested in medical research (“network members”) can provide the information necessary to setup the methods and rules for use by the other components to run their “project” (clinical trial or medical research, or other clinical analysis need). Network members can have as many projects setup as they like.

In one embodiment, healthcare providers may also complete and store profile information on research that is of interest to them so that they can be notified automatically when new research and trial projects corresponding either in part or in their entirety to a profile are setup. For example, the profile may contain medical conditions, diagnosis codes, medical specialties, drug and/or device names, and other information to denote items of interest to providers. They may not desire to supply patient information to the targeting system until such projects become available. This information is then stored and when a new project is setup providers are notified via their preferred communication method that a project is now available. Providers can then begin to provide patient data to the targeting system that they believe may qualify for the projects. Patients may also opt-in to the network and fill out a profile information form and/or provide medical records for inclusion in the network so that they can be automatically notified of projects that match their profiles/medical records currently or in the future as they are setup.

In the Trial Setup method network members provide:

Targeting Rules

Qualification Forms

Qualification Rules

Extraction Rules

Collection Rules

Distribution Rules

Details on these rules and forms will be provided further below.

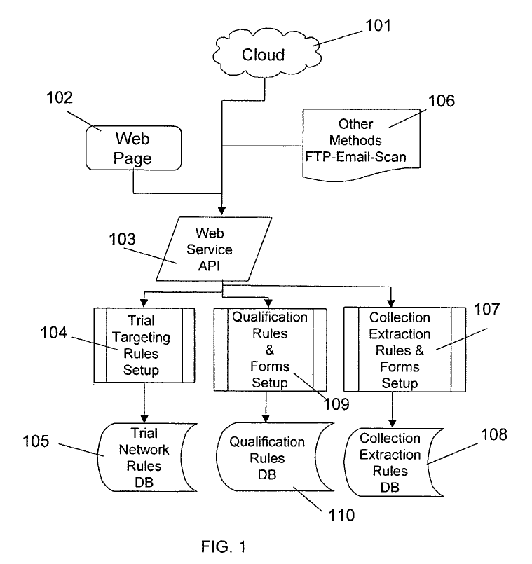

The above information can be provided at a network member web site in steps as shown in FIG. 1, via a network 101, which may be the Internet via a Web Page 102, via Email or FTP 106, directly via a Web Service application programming interface (API) 103, or through the completion of paper forms. The information is then stored in a series of databases which are accessed by the other modules to perform their functions. The information is recognized and processed by a relevant computer program module, which creates the rules in a computer usable form and stores the rules in a related database.

Examples are shown in FIG. 1 wherein a Trial Targeting Rules Setup module 104 extracts or creates the rules from provided information and stores the rules in a Trial Network Rules Database 105. A Qualification Rules and Forms Setup module 109 extracts or creates rules and forms from provided information and stores these in a Qualification Rules Database 110. A Collection, Extraction Rules and Forms Setup Module 107 extracts or creates rules and forms and stores these in a database 108. Other modules that are required to set-up a rules can be provided to extract rules and forms are possible and are fully contemplated. A set of rules and forms as provided by a network member are thus stored and available for use. The stored rules and forms will be provided a unique identifier which associates them to a specific source, such as a project or a network member. It is contemplated that different projects may be alike or similar in their set-up. As a further aspect of the present invention sample templates with pre-set rules may be stored in the databases and can be retrieved, for instance through the web interface 102 by a network member. The rules can then be modified to meet specific requirements for a new project and stored in the database under a unique identifier related to the new project.

The information that is stored in the databases can be accessed by the other modules to perform their functions. Information about the network member is stored in a separate Network Member DataBase (DB). The databases that may be available include but are not limited to:

### a Network Member DB

### a Targeting Rules DB

### a Qualification Rules DB

### a Collection and Extraction Rules DB

### a Distribution Rules DB

Network members can access and update the rules and information about their particular project(s) at any time. They can also enable, disable or close the project. These updates may occur in close to “real-time” thus enabling network members to quickly change requirements as their needs change.

### Targeting

Targeting is the process of searching and retrieving from a database a record of a patient that meets a certain profile that is a requirement for a project. The process of targeting for a project takes place in accordance with Trial Targeting Rules that were provided for this project and that are stored in the Trial Network Rules Database.

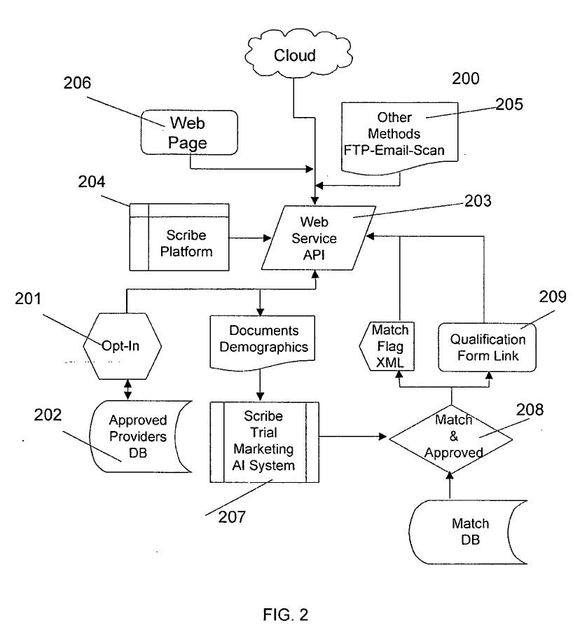

The targeting module 200 of which a flow diagram of its steps is shown in FIG. 2 provides an instantaneous method of reviewing and analyzing clinical information to determine whether a particular patient matches the needs of a current “project” based on the rules provided by network members. If the patient matches then the “provider” (Doctor, Healthcare System, Patient themselves) of the patient is notified. The provider can review the detailed information about the “project” and may determine whether or not they would like to see if the patient further qualifies for actual participation in the “project”. If so, they are presented with qualification information.

Providers must first “opt-in” to the targeting system to have their patient information automatically reviewed as is shown in step 201. This ensures that HIPAA compliance is followed and that providers understand exactly what is happening to their patient data as it goes through the targeting engine. Providers can opt-in for all or just selected patients in their records. They can change their participation at any time.

Clinical information is provided to the targeting module in a variety of ways and may or may not be encrypted. Other data transferred within a system, a network, or by methods provided herein as one or more aspects of the present invention, may be encrypted or may be partially encrypted or may not be encrypted.

Approved provider and patient information is stored in a Provider Database 202. The targeting module will run only against information for these approved providers/patients.

Targeting may be open to any provider and available for use with any system they may use. Clinical information is provided to the targeting module in a variety of ways: for instance from a network through Web Service API (203);

from a Scribe Platform (204) which will be described later in more detail which may be connected to an API (203);
from a FTP/Email/Scan (205) connection to an API (203);

### A Health Level 7 or HL7 Feed;

### a Provider Web Site (206).

The indication Cloud in FIG. 2 and other figures indicate a network through which data may be provided. Such a network may be the Internet.

These methods, particularly the Web Service API and the Scribe platform allow the provider to go about their normal process of patient encounters and encounter documentation in the form for instance of clinical records as entered during or after a patient visit or treatment. As the documentation is created, it is simply passed through the Targeting Module 207 and instantaneous matching and notification occurs in step 208.

On the Scribe Platform 204 this notification takes the form of a highlighted patient record which the physician can see as he/she reviews and approves the clinical documentation for that patient. When the provider clicks on the targeting link they can review the project information and decide whether they want to make the patient available for qualification. If they do they simply click on the qualification link and answer the information themselves or securely send the link to the patient or another staff member to complete.

On systems external to Scribe, the Web Service API 203 provides the information back to the calling system on whether the patient referred to in the particular document matches a project and if so provides detailed project information and links to qualification procedures.

### Qualification

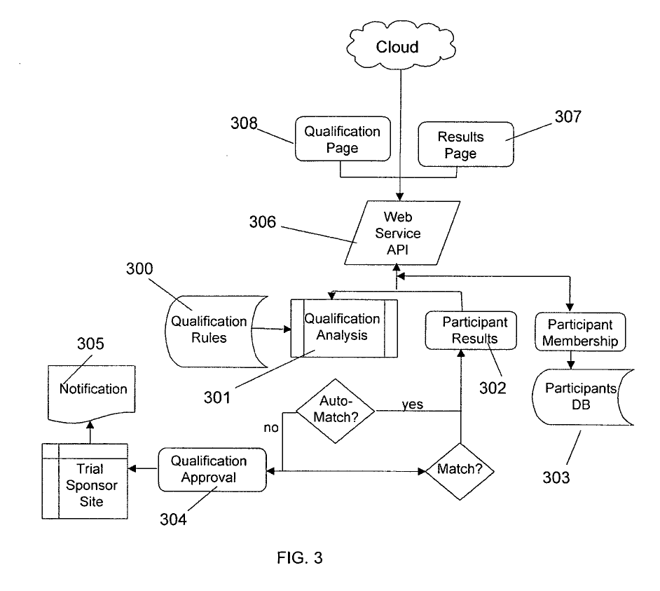

Once the targeting module has determined that a patient may qualify for a particular project, a qualification web “link” or hyperlink is provided to the provider as part of the qualification process as shown in FIG. 3. This web link directs the provider, staff member or patient to a secure web site where they can answer further questions required by the network member to determine if the patient actually qualifies for the project. The questionnaire can also be provided in for instance a Microsoft Word document format so that the information can be entered “offline” as well.

The information gathered from the questionnaire along with the basic patient information is analyzed by the qualification engine 301 in real-time which may be provided with qualification rules 300. There are two types of results that are possible. Either the patient will instantly qualify or not qualify for the project or the network member must review the qualification questionnaire in more detail and then let the provider know the results in step 302.

If the patient qualifies instantly, the patient then is added to the participant database 303 for the project and provided with a secure login id/password to a participant web site. Providers that have qualified patients will also have a secure login id/password provided to them. Patients can track and access information on all projects they are part of from this web site. Providers can track and access information on all patients and their projects. Both providers and patients have the ability to update certain information and determine whether they wish to continue in the project at any time.

If the questionnaire must be reviewed by the network member, it goes to an approval queue 304 for that network member. Network members may be notified, for instance, via email/phone 305 when there is new information to approve or they can simply periodically check the approval queue 304. A designated network member staff may login and review the qualification information and decide whether the patient qualifies or not for the project. The results are then transmitted back to the provider/patient in the manner they listed to be notified when submitting the qualification information—email, fax, or phone, which may be via an API 306.

Network members also have the ability to view qualified participants and information at any time through a network member website. Results can be viewed on a results web page 307. Qualification can take place on a qualification web page 308. As such they can suspend participation in a project for a provider/participant as needed.

### Extraction

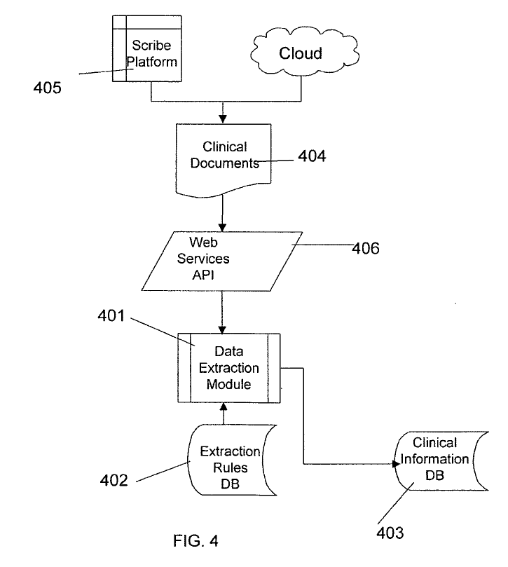

As clinical documentation and information is created as part of further patient encounters with qualified participants, that information 404 is automatically captured, analyzed and extracted by the extraction module 401 as shown in FIG. 4. The extraction module uses the rules setup by the network members in an earlier step and shown again in FIG. 4 as 402 for each project. These rules can include de-personalizing the information as well as reformatting and extracting just portions of the information. Providers, therefore, do not have to go through efforts to submit information 404 in alternative forms from which it is available, thus greatly streamlining and simplifying the process.

Clinical information and documentation may be provided to the extraction module through for example:

Tight Integration with the Scribe Platform 405;

The Web Service API 406;

Email, FTP; or

Participant Web Site.

However, other channels may also be used.

Extraction rules can take a variety of forms, including but not limited to:

### XSLT Transformations;

### Pattern Matching;

### Template Parsing; and

### Search Algorithms.

Extracted data is then stored in the Clinical Information Database 403 for eventual distribution to the network member. Network members, providers and participants may be provided with an opportunity to securely review the extracted data for instance at their respective web sites.

An example of an extraction is for a rule to focus on the existence of a particular medical condition, for example migraine. While there may be many visits of a particular patient to a doctor, and much paperwork created, only those documents that discuss the migraine condition would be targeted for extraction. In addition, once a document is selected for extraction, then either the entire document or targeted sections of the document will actually be extracted. For example, the extraction may be setup to only pull information on medications and observations sections of the documents related to migraines.

### Collection

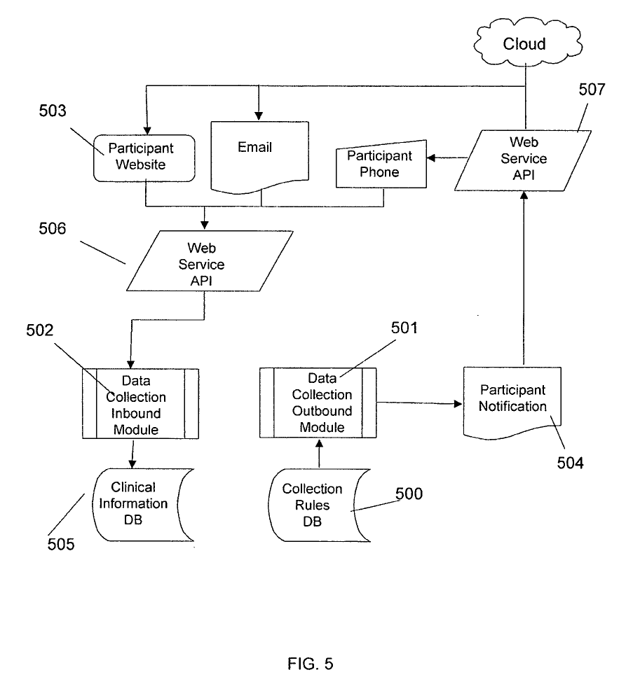

Some projects may require or optionally desire the collection of additional information from participants or providers. This is shown in FIG. 5. There are two collection modules: the Data Collection Inbound Module 502 and the Data Collection Outbound Module 501. Module 502 may receive data from a participant web page 503 for instance via an API 506. Module 501 may provide a participant notification 504, for instance via an API 507 to a preferred contact method for the participant.

The Data Collection Module Outbound may initiate the collection of information through different methods, for example via a phone call or email. The participant is invited to provide the data based on the invitation generated by the Outbound Collection Module. The Data Collection Module Inbound then does the actual collection of information from the participant. The collection modules facilitate this goal by simplifying the collection process and integrating it with existing clinical documentation processes where possible. The collection rules DB 500 that was provided earlier with the rules to collect data provides the Outbound module 501 with the instructions to collect relevant data from external sources. A unique identifier is associated with related requests and a response to the request is processed by the Inbound module 502. The Inbound module associates the data with the correct project through the unique identifier. In one embodiment the Inbound data is already in the correct format and can be stored in the Clinical Information Database 505. In another embodiment the data is not in the appropriate format and will be guided through the extraction process as described above. Additional information can be provided through for instance:

Participant Web Site

Provider Web Site

Email, FTP

Scan

Phone

Integration with Provider Dictation Phone Systems

Participants/Providers may be notified of these additional collection(s) by their preferred notification method—phone, email, text message, Scribe Platform Integration, Web Service API integration to remote system.

Network Members can add collection routines at any time for the project. These can be one time routines or recurring routines. They can include any or all participants for a project. Collected data is stored in the clinical information database 505 in FIG. 5 for ultimate distribution to network members which may be identical or is partially identical to database 403 in FIG. 4. Collected data may be available for review by network members, providers and participants on their respective web sites.

### Distribution

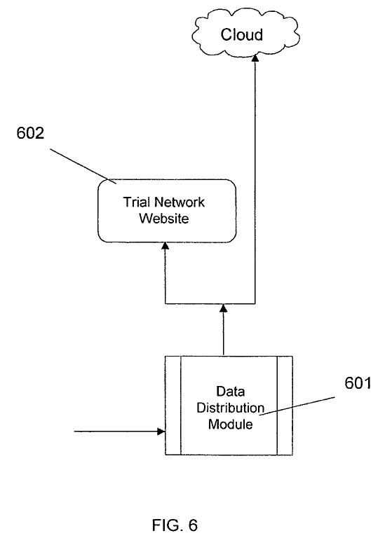

Data stored in the clinical information database 505 is available to be distributed at any time to the appropriate network member by the Data Distribution Module 601 shown in FIG. 6. The rules for how, when, what, and where to distribute the clinical data are stored in the distribution rules database, which was filled during the set-up of a project.

The information may be distributed via:

Web Service API

FTP

Email

Paper

PDF

Network Member WebSite download (602)

Other channels are also possible. Network members can use the network member web site 602 to change their distribution rules at any time.

### Tracking

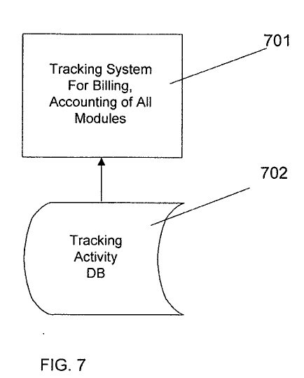

The tracking system 701 shown in FIG. 7 monitors the activities of each module and keeps appropriate statistics on each. The tracking activities are stored in a Tracking Activity database 702. The activity data and related statistics may provide the foundation for, for instance, billing, accounting and management of the network. Activity data may include data on activities like:

Projects Setup

Projects Active

Patients Targeted

Providers Opt-In

“Documents” reviewed

“Documents” extracted

“Documents” collected

Patients Qualifications Checked

Patients Qualified

“Documents” distributed

In setting up a project network, members may set the benchmarks for some of these tracking statistics which may then be used to determine the compensation due for running the project.

Accordingly, different and often time consuming steps in a clinical trial may be automated by setting, implementing and executing rules related to what may include the selection and qualification of participants and the collection, extraction and distribution of information. The following provides an illustrative example.

A new project is looking for people that are currently taking two specific medications, for instance Drug_A and Drug_B. The potential participants must be male and be between the ages of 30 and 50 and live in the United States. Once this project rule is enabled, all the patients seen by providers that have opt-ed in to the system will have their patient documentation screened to see if they meet those rules. If they do, the provider will be notified. The provider will then have the potential participant or the provider's office staff to complete the qualification forms and submit them for approval. Approval may be done substantially automatically by a computer, with potentially a review by a person. If approved, the participant and provider will be notified. All documentation from that provider for that patient will then be collected. Additional collections may be scheduled to collect information directly from the participant. For instance, a collection rule may be the providing the participant with a questionnaire via e-mail with questions related to the project. Such a questionnaire may have simple yes/no questions, questions that may have ranges of answers, for instance related to blood pressure, or questions that have numbers as an answer such as number of tablets Drug_A and Drug_B taken each day. Other type of questions may also be asked.

Documentation the provider creates will be automatically extracted and formatted for use by the network member and ultimately distributed to the network member in the format they require. An extraction rule may be focused on collection of information from assigned fields in a document such as vital signs such as Pulse, Temperature, Blood Pressure. A rule may also extract sentences or paragraphs using specific terms such as migraine, Drug_A, etc. A rule may also extract specific paragraphs that are pre-marked as being related to a project. For instance, a paragraph in a provider document may be designated as Project Participant Update with a date assigned to it. An extraction rule may be to extract such a paragraph from a document. A distribution rule may be a list of persons or institutions that should receive documentation. For instance, a distribution rule may be a list including an e-mail address of a reviewer with a preferred format being a headline summary, a researcher with a preferred format being all available information and an administrator with as a preferred format a listing according to a classification of activities over a period. Other distribution rules are possible. It is to be understood that the above examples are illustrative examples and are not limiting. Other rules are possible and fully contemplated.

The identifying of a patient as a potential participant in a clinical trial is thus based on a first set of parameters related to the requirements of the clinical trial. For instance, in the above example, a clinical trial is focused on users of two drugs: Drug_A and Drug_B. Clearly the use of Drug_A and Drug_B should be among the parameters for identifying a patient as a potential participant. Other examples of selection parameters for identifying a potential participant may include: an existing illness, an existing complaint, age, weight, gender, blood-pressure, pulse, temperature, use of drugs, one or more symptoms such as a cholesterol level within a certain range, and one or more symptoms such as a cholesterol level outside a certain range. Life style, heritage, type of profession, education, place of birth and many other parameters may be included in a first set of parameters to identify a potential participant.

Once a patient is identified as a potential participant, one may qualify the patient as a participant. A second set of parameters may be applied to qualify a potential participant as an actual participant. The second set of parameters may comprise some or all of the elements of the first set of parameters. The second set of parameters may have narrower of broader margins than the first set of parameters. For instance, in the example, one may want a participant who uses Drug_A and Drug_B but no anti-inflammatory drugs of a certain brand. The second set of parameters may also comprise availability of a patient to visit a hospital or clinic on a regular schedule for a period of time. The second set of parameters may have an approval form signed by a patient. A clinical trial may be a double blind trial wherein a patient may be provided with a placebo. A patient may not be willing to participate in such a trial.

Accordingly, a first set of parameters which may also be called a set of identifying parameters for identifying a potential participant in a clinical trial may have a set of parameters that is usually available in patient data. A second set of parameters which may be called a set of qualifying parameters for qualifying a patient as a participant in a clinical trial may for instance require first providing an explanation to a patient.

It should be clear that the first set of parameters for identifying a potential participant and second set of parameters for qualifying a participant depend on the nature of the clinical trial. Some parameters such as age, gender, weight, blood pressure and age may be common to many clinical trials. It will be clear that the range of these common parameters may vary per clinical trial. In the case of, for instance, a clinical trial of a very uncommon illness or infection these parameters may not play a significant role. In many clinical trials other parameters may be required to identify and qualify a participant.

A set of parameters may also be part of a collection rule. It may include parameters of the type of communication for collection such as: e-mail, website, automatic collection, fax, scanned document, telephone, etc. It may also have parameters that include frequency of collection, day of collection, etc. It may also include e-mail addresses, URLs, phone numbers, IP addresses, etc including alternate addresses if an address does not respond to a request for collection. One may call these parameters collection parameters.

A set of parameters may also be part of an extraction rule. It may include parameters of the type of extraction based on where the data is stored. For instance, if the data is stored in a database, the parameter may be a field in a database. If the data is stored in an XML format the parameter may be a tag. If the data is stored in a text document the parameter may be a sentence or a paragraph containing a word or term. A parameter may also indicate a level of detail of data to be extracted. One may call these parameters extraction parameters.

A set of parameters may also be part of a distribution rule. A parameter may indicate a recipient or a group of recipients. A parameter may relate to the manner of communication on how the data will be distributed such as e-mail, data-file, fax, web page. A parameter may indicate the content to be distributed and/or the level of detail included. A parameter may also indicate how often data may be distributed to a recipient. Some recipient may require immediate receipt of data as soon as it becomes available. Other recipients may receive data in an aggregated format once very week or month for instance. One may call these parameters distribution parameters.

### The Clinical Trial Dashboard

By assembling and storing patient data in one or more databases that apply a common meta-data model and structure one is now able to search the data and provide aggregated statistics and historical data of the patients in a trial. For instance, one may provide a quick statistical overview of the different age groups of patients in a trial. In a further example, one may provide a comparison of age groups of patients in a trial group and patients in a control group. In a further example, one may provide medical indicators such as for instance blood pressure over age groups, and over time as participants in a trial use a certain drug. One may also select to display specific data: for instance one may want to display the blood pressure data of people in a certain age group with a certain ailment over a period of time while using a medication. Other searching, collecting, processing and displaying of data from data available in the system is possible and is fully contemplated.

The display of data can be in character form such as columns of data. The display can also be in graphical form such as in bar diagram, pie diagram or in any other form that can be useful for reviewing data. In one form, the data can be displayed as an alert, for instance when vital signs of patients are indicating a problem for a patient. One may also display data in a graph that provides a trend. Another example may be a red, yellow, green light pattern which shows red for immediate problems to address, yellow for items to begin to watch and green for items that are fine and need no attention.

### The Scribe Platform

As stated above, the systems, networks and methods for clinical trials and medical research as provided herein can be tightly integrated with the Scribe Platform or parts thereof and would create a novel and beneficial solution for clinical research as yet another aspect of the present invention. The Scribe Platform is a web based set of tools for the creation, production, storage, workflow management, communication, sharing, coding, and analysis of clinical information. It is built on an Internet accessible clinical information repository. The platform is a product/service owned and marketed by Scribe Healthcare Technologies, Inc. 736 N. Western Ave. Suite 152, Lake Forest, Ill. 60045. The Scribe Platform creates from patient records including dictations from a physician or practitioner dealing with a patient a database or repository of searchable data that can be parsed and organized for different and specific applications. This allows patient data that is entered in a routinely fashion to be made available and updated in an easy manner for use in for instance a clinical trial. The use of the Scribe Platform in a clinical trial network or platform would pre-empt the need for data pre-processing such as dedicated data entry, data transformation, and data scrubbing, because the data on the Scribe Platform is already designed to be ready for clinical application.

The Scribe Platform comprises but is not limited to the following components.

EZDictate: Scribe's standalone digital dictation system includes support for telephone dictation (VRS) and digital handheld management. VRS supports secure user id and password access with multiple billing capability, template selection, and full-featured dictation management. Digital handheld management provides for both email and secure FTP transfer and tracking of dictation files.

Digital Dictation VRS 6.5 with VR: Scribe's digital dictation management system includes support for telephone dictation (VRS) and digital handheld management. VRS supports secure user id and password access with multiple billing capability, template selection, and full-featured dictation management. Digital handheld management provides for both email and secure FTP transfer and tracking of dictation files. Backend Voice Recognition (VR) is available for both methods.

MT Platform 5.0: Scribe's online medical transcription production, workflow and company management system. It allocates work automatically to individual transcriptionists and tracks productivity in a HIPAA compliant environment, with productivity enhancing cost, billing, accounting, and analysis/reporting tools. Dynamic document creation with MT templating capabilities is also included. It also has rules based processing capabilities.

MD Platform: Scribe's MD Platform is the central point for management of a patient documentation process. One may receive, manage, fax, email, track, analyze patient information in this online anywhere, anytime accessible platform. One may add PatientChart (described below) to centralize all patient information (images, lab results, prescriptions, etc) in one location or in one database.

Reporting: This Scribe module provides administrative reporting and analysis of your documentation process. It provides clinical research capabilities for a medical or a project team. It provides cycle time, deficiency & disclosure, and volume reports. This allows speeding up a revenue cycle management by making sure documentation is completed quickly and easily while pinpointing problems with minimal effort.

Inbound/Outbound Interface Engine: This Scribe module performs the import of dictations, demographics, x-rays, images, and other information directly into the transcription process or MD Platform from ADT legacy and/or other systems. It can deliver necessary information back to required systems as required.

Transcription Marketplace: Scribe has assembled a global network of transcription companies available for referral. One may simply select the vendor(s) that match a requirement for instance on quality, turn-around-time, and pricing that match one's needs. If needs change, changing vendors is easy and seamless.

Patient Portal: Scribe's Patient Portal provides HIPAA compliant access to medical records for a patient population and streamlines a registration process by collecting demographic, medical history, and billing information from patients.

PatientChart (EMR Lite): Scribe's PatientChart provides many of the benefits of an EMR/EHR with low expense or complexity. One may centralize all patient records in a single organized repository and electronic chart, accessible from any location via the Web. One may thus streamline dictation/documentation processes, reduce paper, improve compliance, analyze outcomes with timesaving tools for physician, administrator, and MT.

Coding Platform: This Scribe platform combines transcription and coding into one streamlined process into Scribe's Coding Platform. Records can be coded and used over and over delivering completely documented and coded encounters to a billing system. Any record can be provided with proper codes quickly and easily attached with the online SmartCoding module which allows the user to select from CPT procedural codes and ICD-9 diagnosis codes and attach them to templates that are used to create a transcription. In doing so the codes are then automatically available to billing systems to be used to bill for an encounter once the transcription is approved.

Analytics—MDStatX: By integrating, cleansing, and normalizing billing data, Scribe's MDStatX is able to deliver answers to important questions regarding productivity, market draw, payer mix, and quality of care. Standard dashboard reports can be created and customized. Users are able to easily drill down through dashboards to provide consolidated statistical and/or historical data.

Other modules and platforms may also be available from Scribe Healthcare.

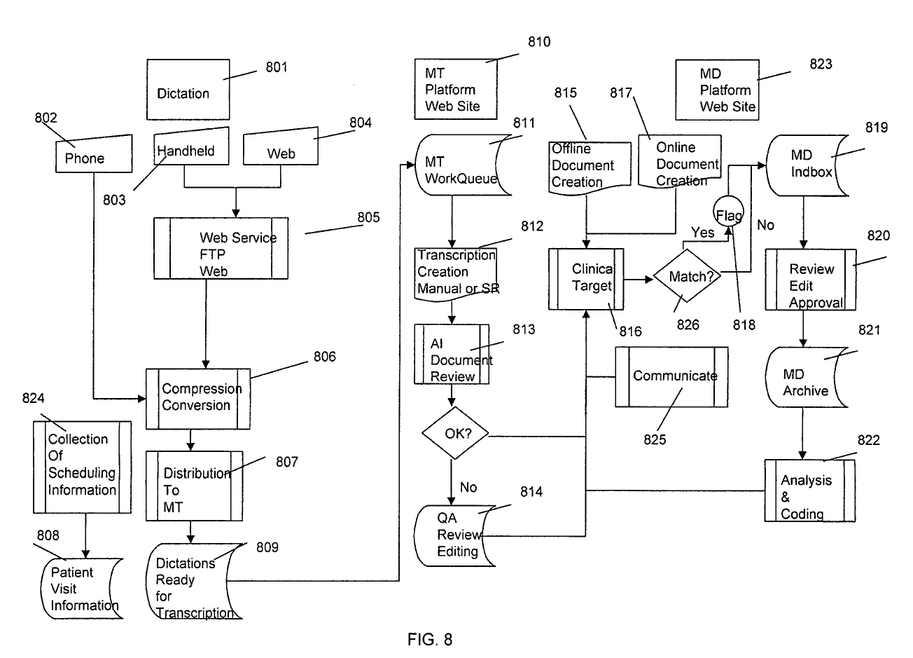

FIG. 8 shows a flow diagram of one transcription and data entry process that can be conducted with the Scribe platform.

The process may usually start with dictation 801 as shown in FIG. 8 by a physician or practitioner related to a patient. The dictation may take place by phone (802) or for instance with a handheld device (803) or by microphone connected to the Internet (804). Dictation collected from Handheld or Web may be transmitted over the Internet (805). The collected dictation is then usually compressed and converted (806) for further processing. The compressed data is distributed to a medical transcriber (807). Collection of Scheduling information 824 provides the transcriber with detailed information about the patient encounter. For example, patient demographics like age, sex, race, marital status, etc. Along with encounter information like doctor seen, date/time seen, location seen, etc. The dictation data is combined with Patient Visit Information 808. The patient data is now ready for transcription (809).

The data may be transferred to a MT Platform Web Site 810 where it is put in a MT WorkQueue 811 and is waiting its turn to be processed. The next step is the actual transcription which may be done by a person or by using technology such as Voice Recognition (812). After creation of the transcription, an AI Document Review 813 may take place that highlights requirements for human review and potential editing 814. The Clinical targeting 814 refers to the integration of the Scribe platform directly to the targeting module web service API as shown in FIG. 2 (204), which provides a tight integration to the system.

### The System

The methods and processes provided herein as an aspect of the present invention can be implemented in a system. A system has at least one computing device with a processor and a memory unit. The memory unit is enabled to store data and instructions. The instructions can be retrieved from memory by the processor which is enabled to execute the instructions and act upon data in the memory. As a result other data may be generated that is stored in the memory or is stored on a database. The database is stored on one or more data storage media which can store data and from which data can be retrieved. The system may contain multiple computing devices and multiple databases. The system also contains a network which is enabled to connect at least two computing devices of the system. The one or more data storage media are also accessible via the network.

The system may contain one or more sub-systems which are connected to the system via the network. The Scribe system, described above may be a sub-system of the system. The components of the system may be in one geographical location. They may also be distributed over different geographical locations. A module or method as described herein may be installed on a single computing device. However, it may also be distributed over 2 or more computing devices. A database may be installed on a single device. A database may also be distributed over several storage devices. A method or a module may be installed on a server connected to the network.

The network may be a single network. It may also be a collection of different networks that are enabled to exchange information. The networks may operate under different protocols, they may also work under one protocol. One communication connection may be associated with Web Services. A connection may also be associated with other communication formats and protocols. A connection from a user device to a server that executes or performs instructions for a method may be a direct connection. It may also be a plurality of connections. Such a connection between a user device and a server may require one or more APIs to be operable. A network may be a wired network, it may also be a wireless network. Connections within a network may use different technologies, which may be wired, or wireless.

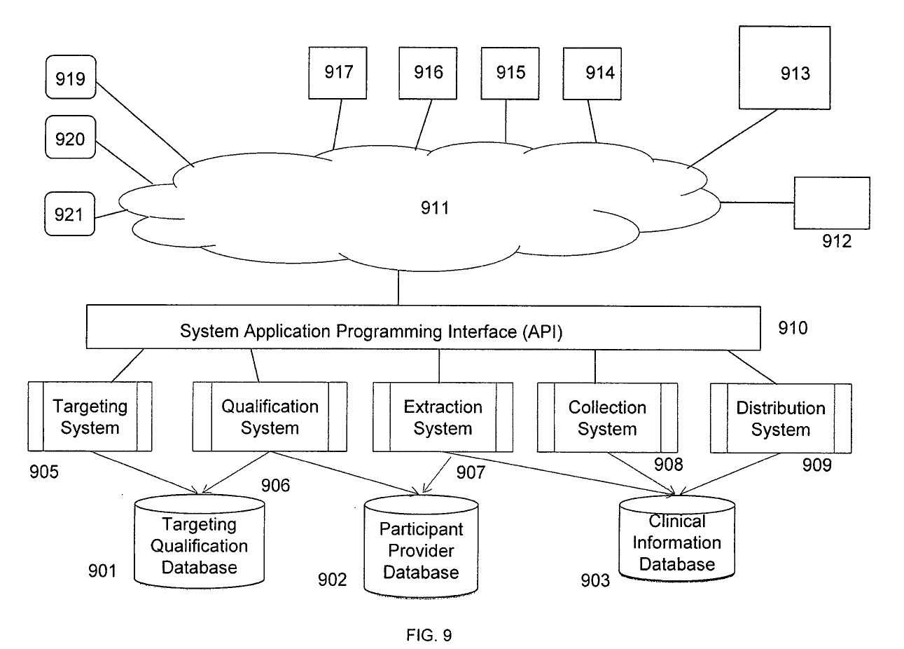

A diagram of a network is provided in FIG. 9 as an illustrative example. It is to be understood that different configurations may be possible. The system of FIG. 9 has at least 3 databases: a database 901 with data related to qualification of participants; a database 902 with data related to participants and a database 903 with data related to clinical information. The three database may reside on one server, they may also reside on 2 or 3 or more servers.

The databases are accessible from different systems or subsystems. All databases may be accessed by all (sub)systems. However, one may also provide a minimum access in such a way that database 901 is at least accessible by a targeting system 905 and a qualification system 906. Database 902 must at a minimum being accessible by (sub) system 906 and by (sub) system 907 which performs extraction. Database 903 is at a minimum accessible by (sub)system 907 and by collection (sub)system 908 and distribution (sub) system 909. Systems or subsystems may for instance be application servers.

All systems, subsystems and databases are accessible for and by system administrators. This access may be for system support, maintenance and administration and is assumed to be present with facilities that allow administrators to gain access from any system access point that is enabled for that purpose.

In normal operations, the access to the databases is through the specific application systems such as 905-909. These applications are enabled to be accessed through different connections and networks 911 via an Application Programming Layer or API 910. A network 911 may be the Internet, or any other network that allows access to the applications. It may, for instance, be a direct connection from a terminal to a server. The connections may be wired or wireless connections. They may be working under a single or a plurality of protocols. The network cloud 911 is assumed to take care of message formats, protocol translations as well as physical connections.

Users may connect to the applications and/or application servers through different means and connections. For illustrative purposes, several possible means for connections are provided but are not limited to those means. For instance, a user may connect to a website or a portal via a computer. For instance, a user may connect via a computing device 919 to a Network Member Web Site. A user may also connect via a computing device 920 to a Provider Web Site. A user may also connect via a computing device 921 to a Participant Web Site. The different computing devices are only differentiated for connecting to different web sites. One of ordinary skill in the art will realize that one may connect to a web site from any computing device that is enabled to do so.

Another way to exchange information in the system is by using a Scribe Platform 912 that can connect to an application via a network or connection 911.

Yet another way to exchange information in the system is by using an existing healthcare provider system 913 that can connect to an application via a network or connection 911.

One may use different devices to exchange data. The devices may be provided with a modem to create the appropriate signals and be in compliance with a protocol. For instance one may use a phone 914 to connect to a server. One may also apply a fax 915. One may also use a scanner 916. One may also use any computing device 917 that is enabled to exchange data. A computing device 917 may be a computer; it may be a mobile phone; it may be Personal Digital Assistant or PDA type of device. It may also be a tablet type of device. It may be any type of computing device that is able to exchange data with an application server.

### Screenshots

An extensive description is provided herein of the clinical research network. Some of its functionality may be illustrated by diagrams of display and system interfaces that can be applied for users. These user interfaces or screenshot diagrams provide additional illustrative examples of the methods and implementations that are different aspects of the present inventions. The examples should not be considered as limiting as different interfaces are possible as would be clear to one of ordinary skill in the art and are fully contemplated.

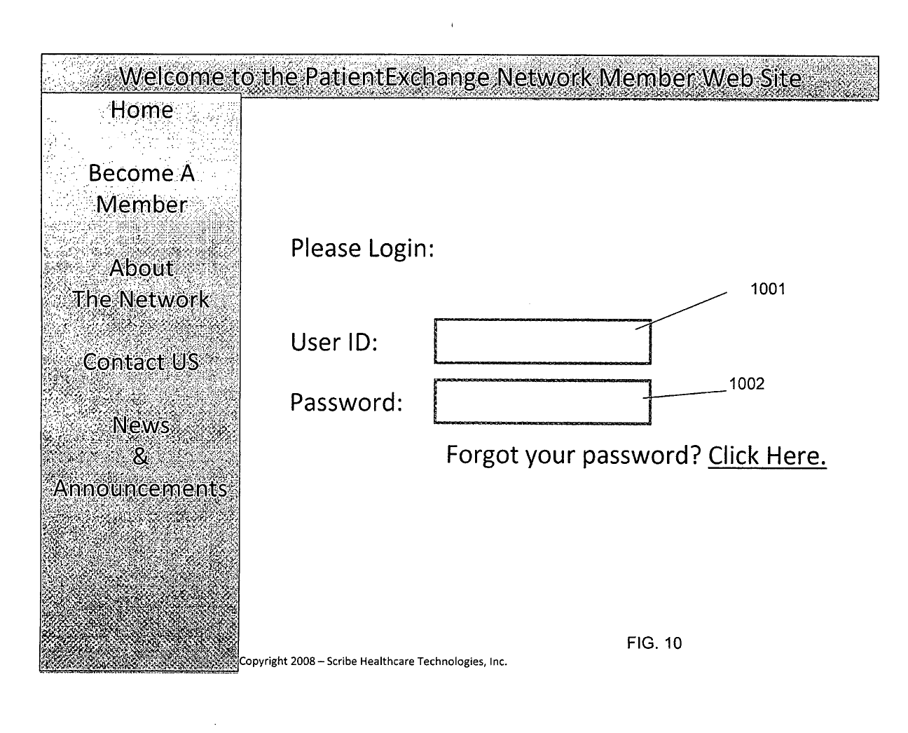

FIG. 10 shows in diagram an illustrative example of a sign-in or log-in web site screen for a network member. In order to gain access a network member has to provide a correct user name in field 1001 and a password in field 1002. Additional information may be available through this web site without logging in.

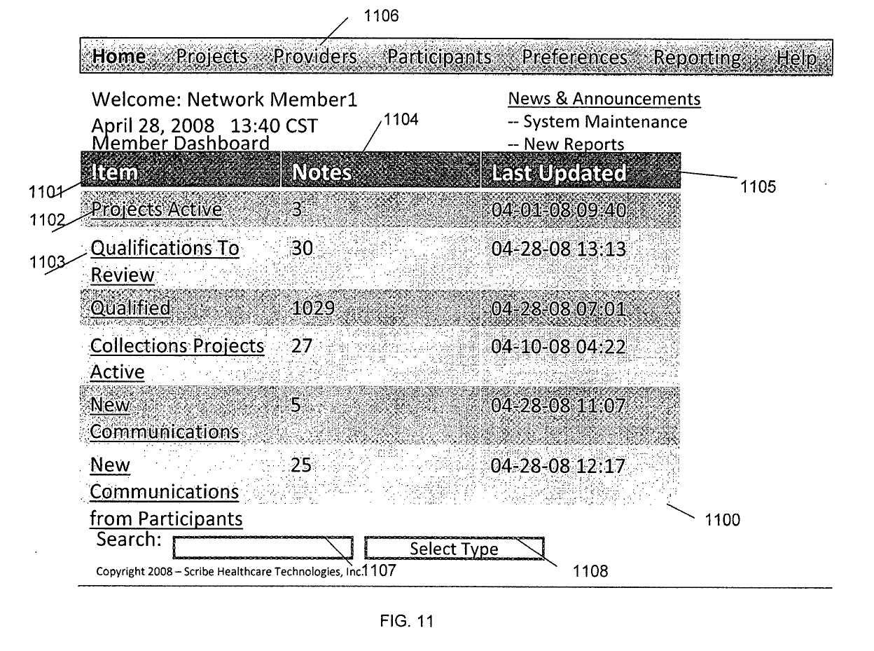

FIG. 11 is a diagram of a network member Home Page. This is a member dashboard that provides a quick overview of the major actions that a network member needs to take or items that are pending. It allows them to click on the “item” and drill down into it. This way the work that they need to do to manage all these projects and participants is in one easy to use place instead of in paper from many different sources. In one embodiment, a screen is presented as shown in FIG. 11. A matrix 1100 lists pending activities or items for review or items that require action by either the member or by somebody else. The matrix in this embodiment is organized using a row for listing the specifics for an activity and a column determining a characteristic of an activity or an item. For instance, column 1101 lists the name of an activity as “Item”; column 1104 which is listed as Notes provides a number related to the Item; and column 1105 provided a data for Last Updated. Row 1102 lists for instance as Items “Projects Active” and provide a number 3, stating that 3 projects are active, and this category was last updated on Apr. 4, 2008.

Row 1103 lists Qualifications to Review, of which there are 30.

A text in the Item column 1101 may be a hyperlink to another web page that provides additional details. Each cell in the matrix may be connected to a hyperlink, although in this example only the Items have a hyperlink.

One may list items in a pre-set order. One may also list items in an order of urgency. For instance, one may provide an additional column that indicates a measure of urgency for attention or action by a member.

Further navigation within available web pages is provided through a menu 1106. A network member may also in one embodiment search for specific items by using search fields 1106 for terms to search on and a field 1107 to narrow a search to types of items to search on.

It should be clear that this is merely an illustrative example of a screen shot and that other embodiments are possible. For instance, if one is managing many projects with many participants over a long period of time, one may provide search facilities to find certain trends, anomalies, or details for specific occurrences.

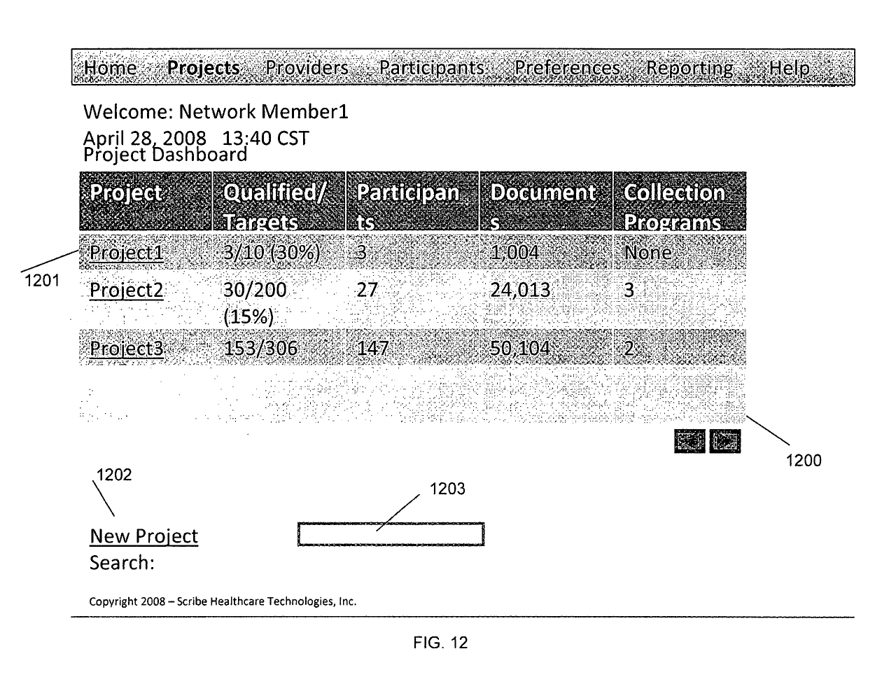

One may click in FIG. 11 on the cell 1102 with a hyperlinked term Projects. This may bring a user to a web page as shown in FIG. 12. One may call this web page a Project Home Page. The statistics on each project are made available on this page. This may tell a network member in a matrix 1200 how well they are doing on targeting and qualifying participants in their projects. For instance, line 1201 shows details on a Project1. It also allows a drill down into the project, by providing for example a hyperlink to the name of the project. One may also change the parameters of either targeting or qualification in “real-time”—instead of trying to figure out how to adjust their numbers over far flung and disparate sources.

The page may also have a search facility 1203. The page may also provide a facility to create a new project by providing a hyperlink to a term New Project in 1202.

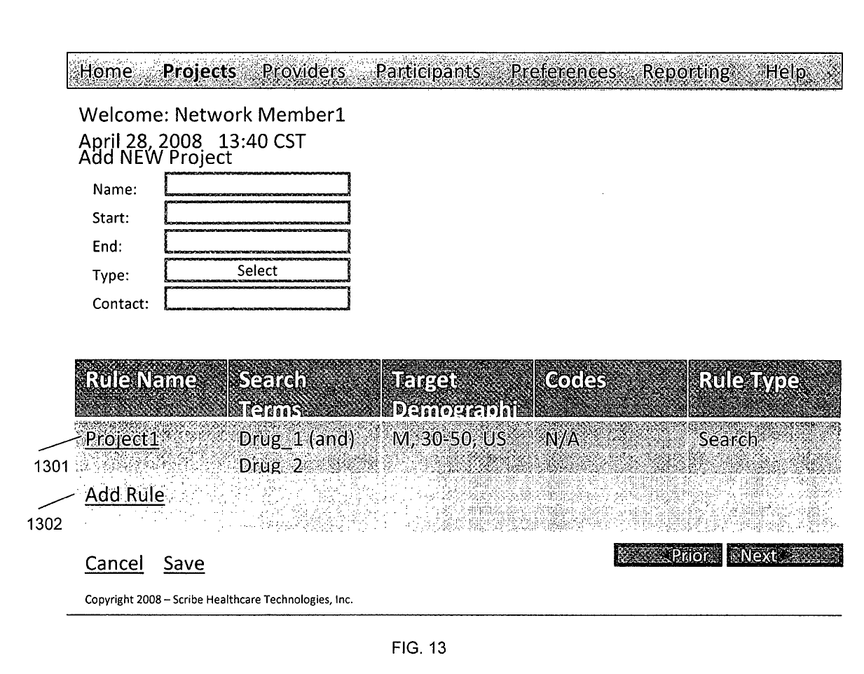

FIG. 13 is a diagram of a web page that may be used for entering a new project. It demonstrates how easy it is to create rules and setup a research or clinical trial project. Many very flexible rules can be created using a combination of techniques, included but not limited to some of the items shown on the page—like particular “terms” within documentation, participants meeting certain demographic characteristics, certain diagnosis or procedural codes associated with billing to name a few. These rules form the basis of a project which is the selection of participants for inclusion in clinical research, trial or other targeting. For example a project could be the selection of people to try a new migraine medication that is targeted only for men between the ages of 30 and 50 that reside in the US and are currently taking two specific drugs.

One may add a new rule by clicking on hyperlinked item 1302 Add Rule.

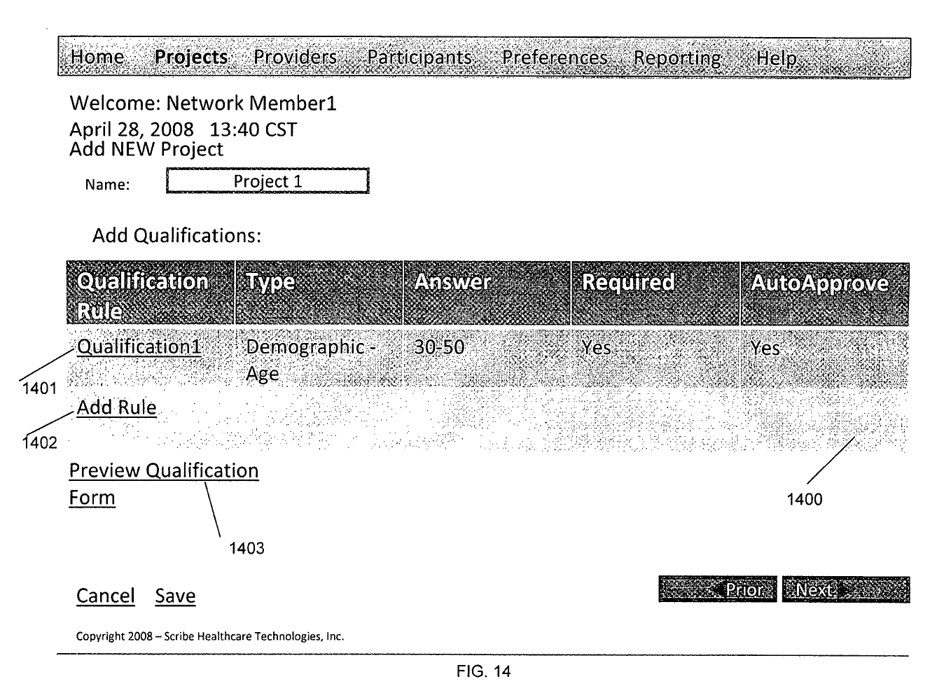

FIG. 14 is a diagram of a web page that may be used for qualification rules in a new project. An overview of qualification features is provided in matrix 1400. Once targeted, qualification becomes a simple process to manage as well as custom forms can be created which will then automatically be presented to targeted participant to complete. A network member can determine whether they want the system to automatically review and approve them based on the answers provided or if they'd like to review each prospective participant individually. This is illustrated in line 1401 of matrix 1400. Clicking on a hyperlinked term 1402 Add Rule, will bring a user to a new web page. The hyperlinked term 1403 Preview Qualification Form will bring up a page with the Qualification Form.

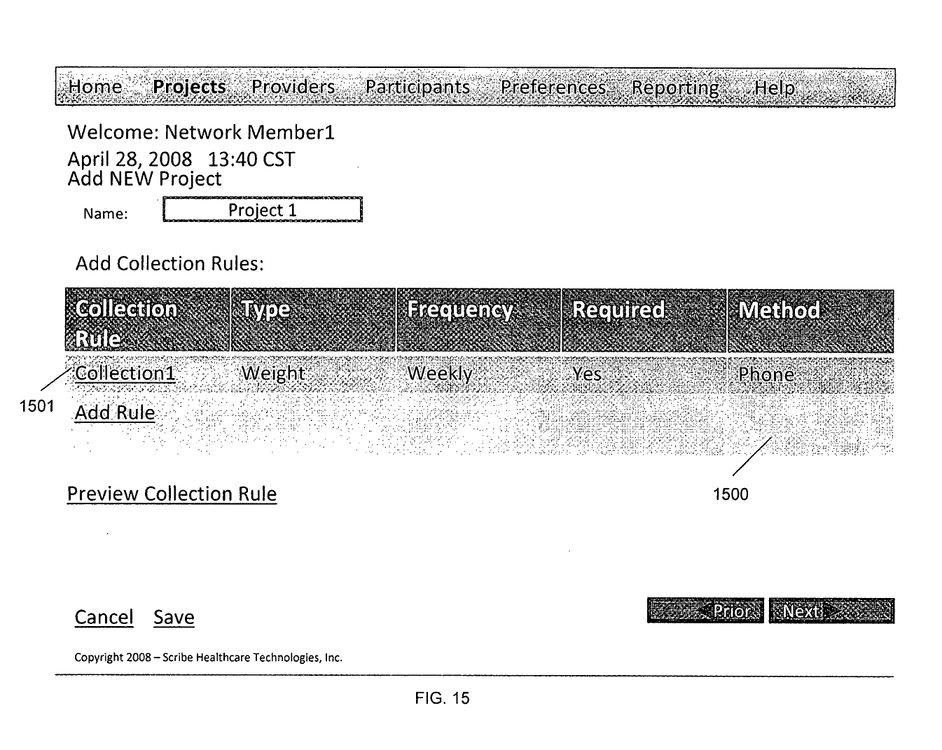

FIG. 15 is a diagram of a web page that may be used for collection rules in a new project. The details are displayed in a matrix 1500. Line 1501 shows characteristics of a collection rule. These rules, like the other rules may be changed in real-time. They show how easy it is to setup and collect information from participants in a variety of ways. It also demonstrates how they can control exactly what is asked and how often it is asked.

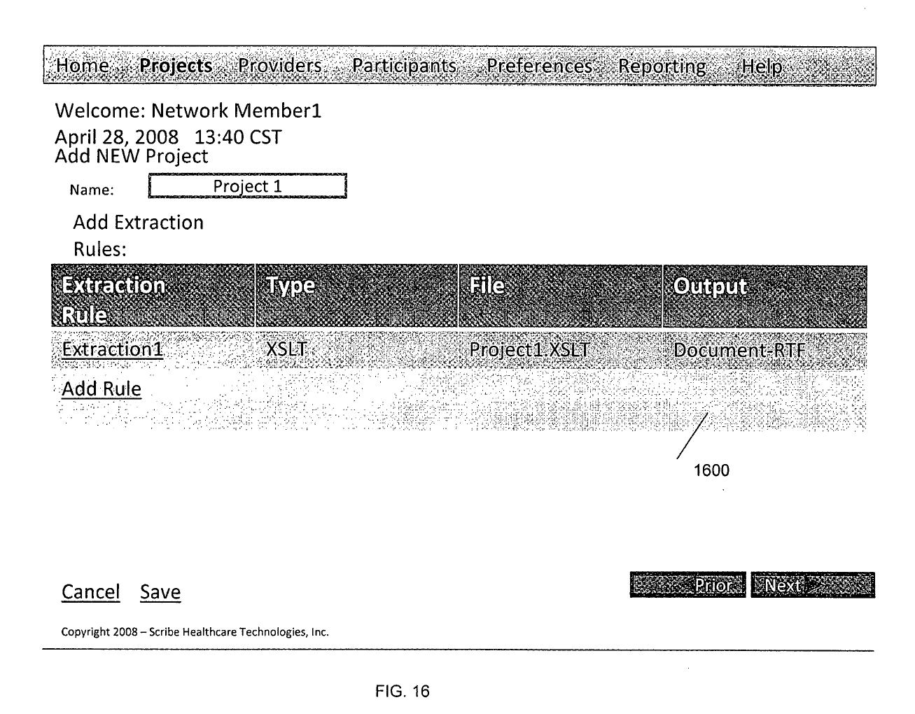

FIG. 16 is a diagram of a web page for new project—extraction rules. This page provides ways to automate the extraction of information passed to the system by providers and participants. It provides for a simple way to change this in real-time and customize the extraction without having to have the provider change their process. Results are displayed in matrix 1600.

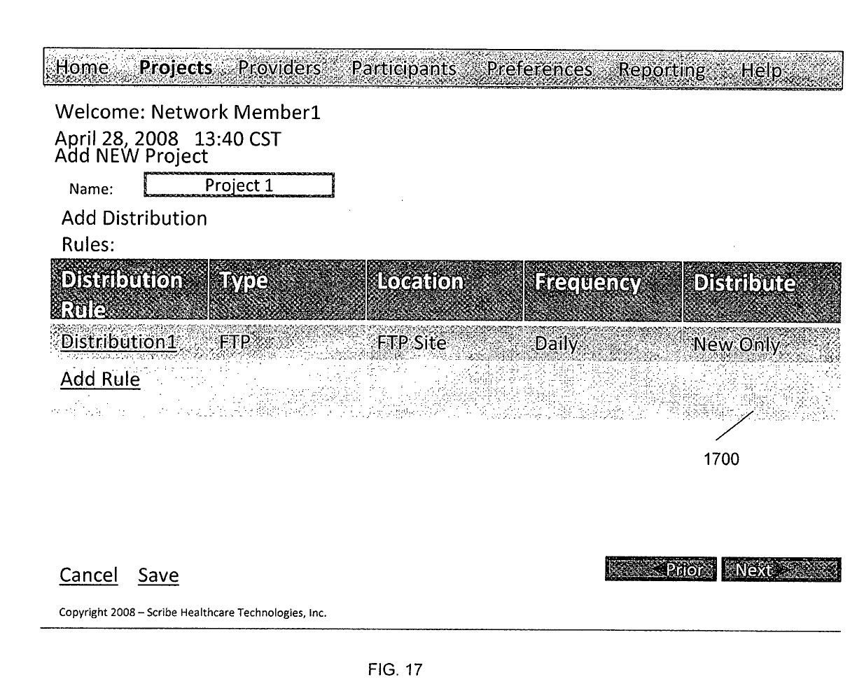

FIG. 17 is a diagram of a web page for new project—distribution rules. This provides for the electronic delivery of information, instead of having to manually go and collect information from potentially hundreds or thousands of providers. Details are displayed in matrix 1700.

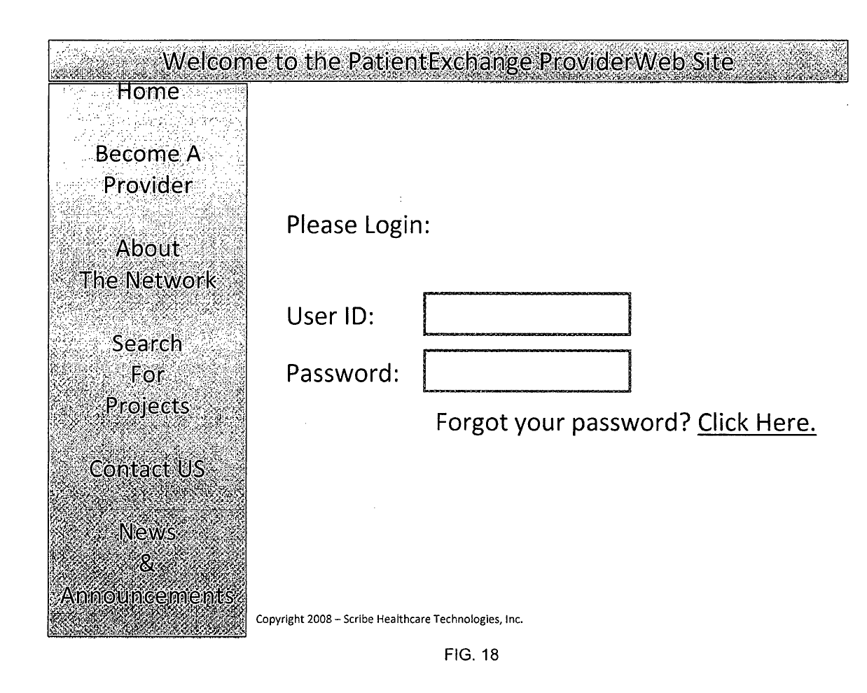

FIG. 18 is a diagram of a log-in web page for a provider.

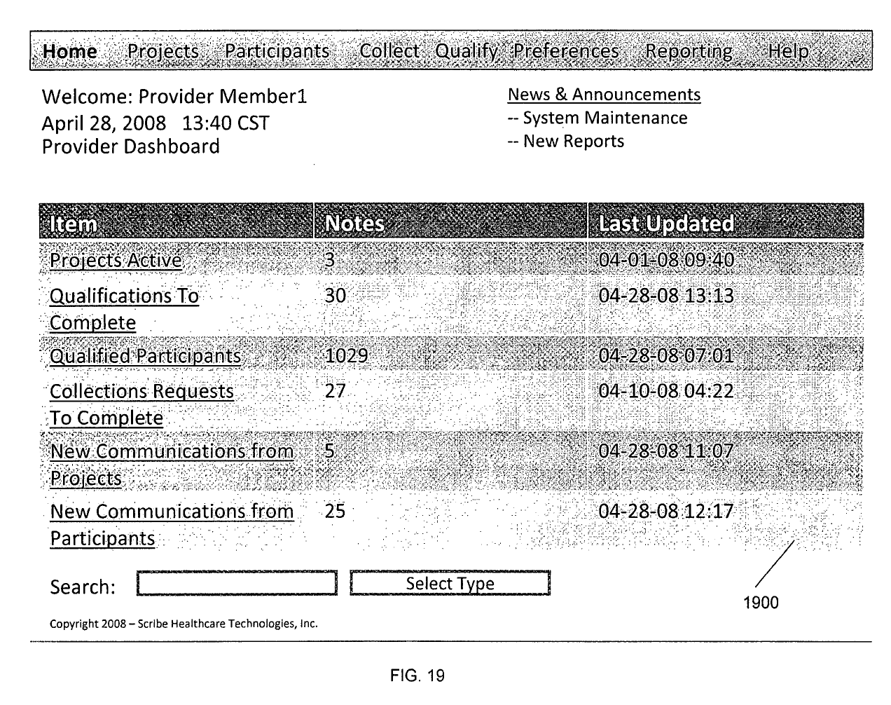

FIG. 19 is a diagram of a provider web site—home page. It lets a provider in a matrix 1900 quickly see tasks they need to do to take care of patients as well as all the projects they are involved in. It makes it easy for a provider to instantly qualify participants, and it enables centralizing communications for all parties in one place. Providers can also search for other projects that they may be interested in.

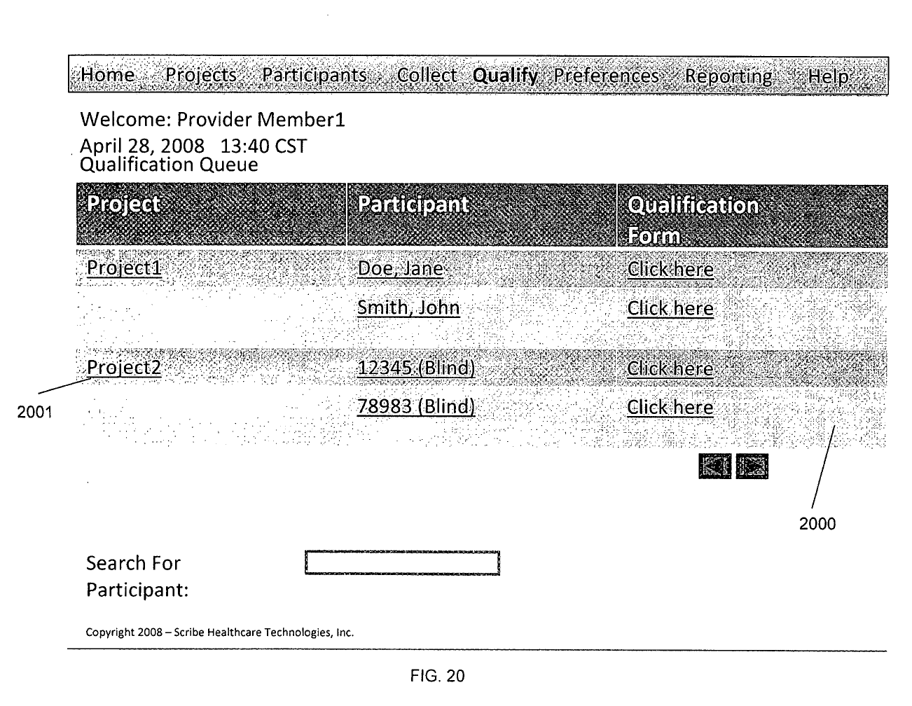

FIG. 20 is a diagram of a provider web site—qualification queue. This web page makes it easy to quickly qualify participants online in real time. Details are displayed in matrix 2000. Details of participants and their qualification forms are accessible through hyperlinks. It is pointed out that line 2001 has no name for the participant, only a reference number. The identity of a participant may be made anonymous by a provider to a network member, a participant and to a clinician working with the participant if a trial is a double blind trial.

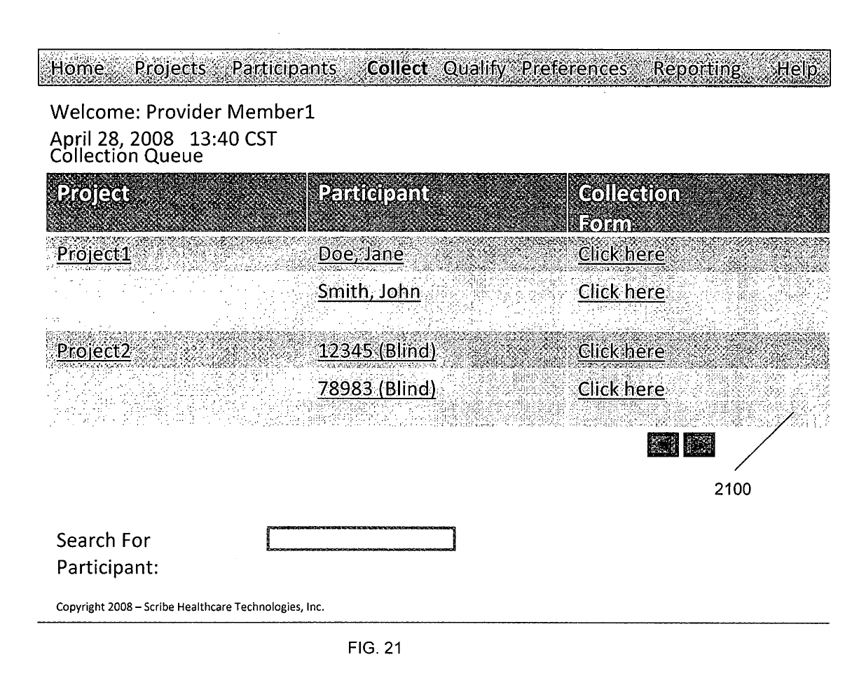

FIG. 21 is a diagram of a provider web site—collection queue. Instead of dealing with a multitude of forms and trying to remember what is required for each project, this allows the provider to quickly provide on-going information for the project. Details are displayed in matrix 2100; and further details on participants and collection forms can be found through hyperlinked terms.

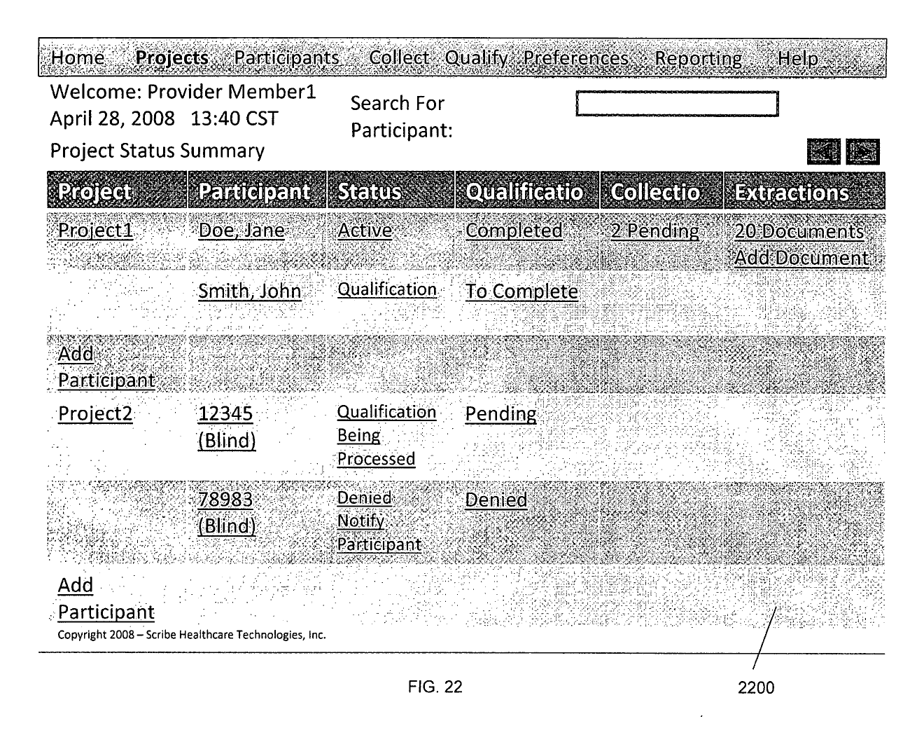

FIG. 22 is a diagram of a provider web site—project home page. It allows a provider to quickly and easily review the status of all their participants in all their projects. Details are available in a matrix 2200. It also provides a way to review the participants' progress through the process and to update information quickly and easily.

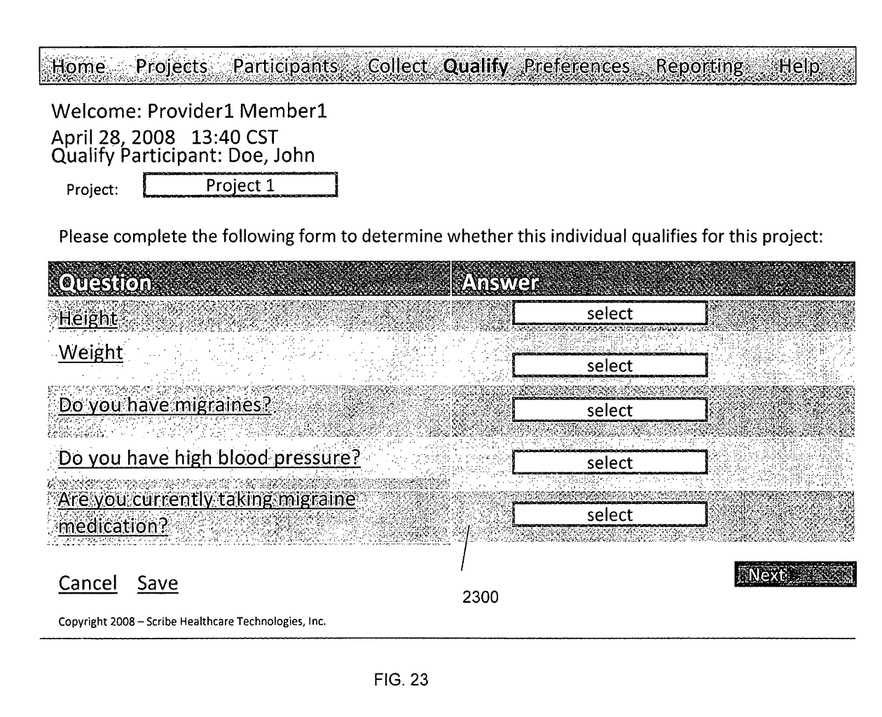

FIG. 23 is a diagram of a provider web site—qualification form shown in a matrix 2300. Providers or their assigned staff can quickly and easily fill out qualification forms for participants if needed.

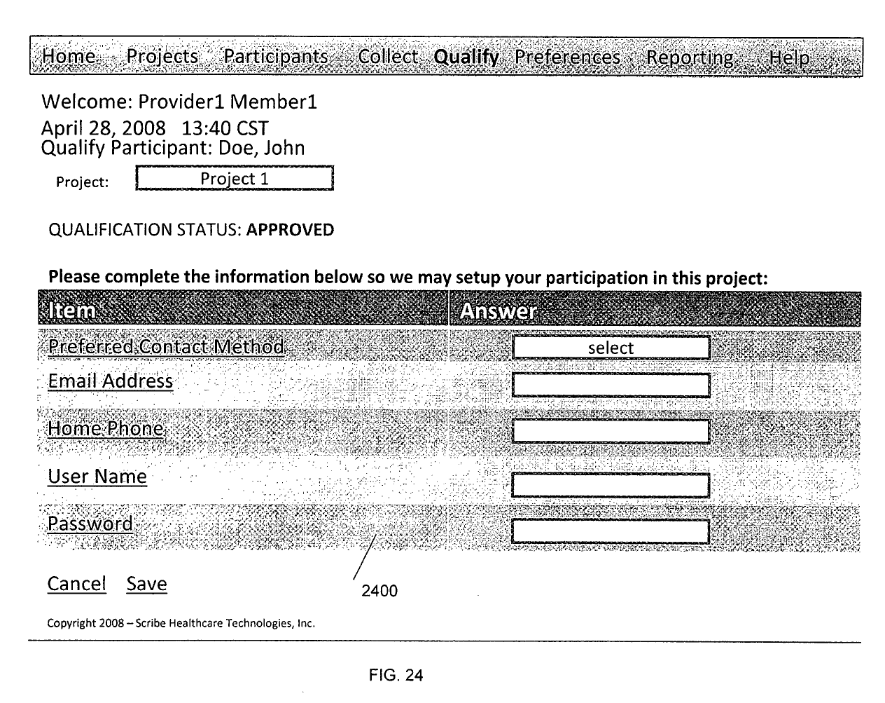

FIG. 24 is a diagram of a provider web site—approved participation completion. Approval may be instantaneous in most cases. Further details may be provided in matrix 2400. It allows a provider to complete qualification for participant if necessary.

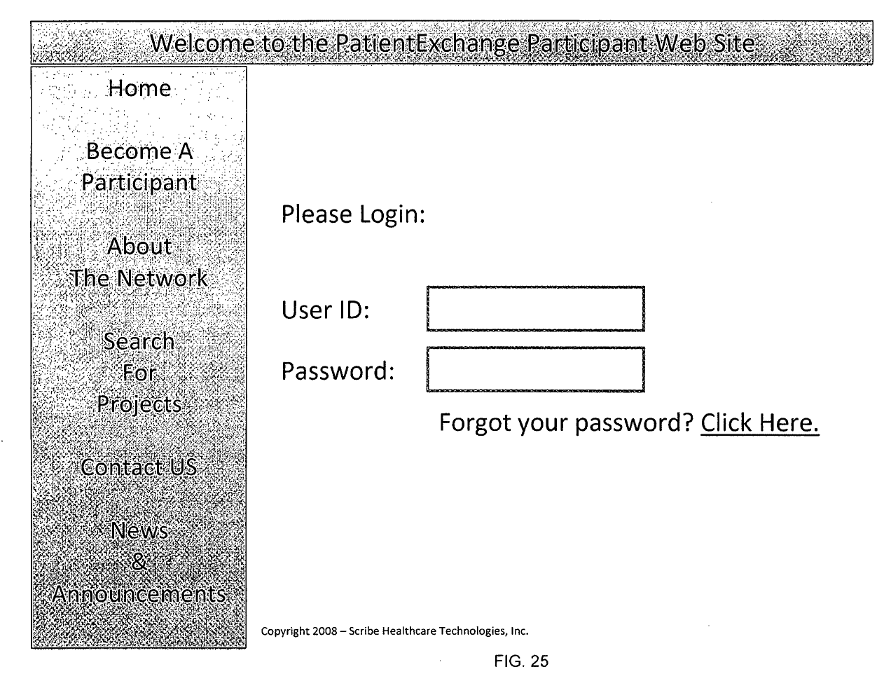

FIG. 25 is a diagram of a log-in web page for a participant.

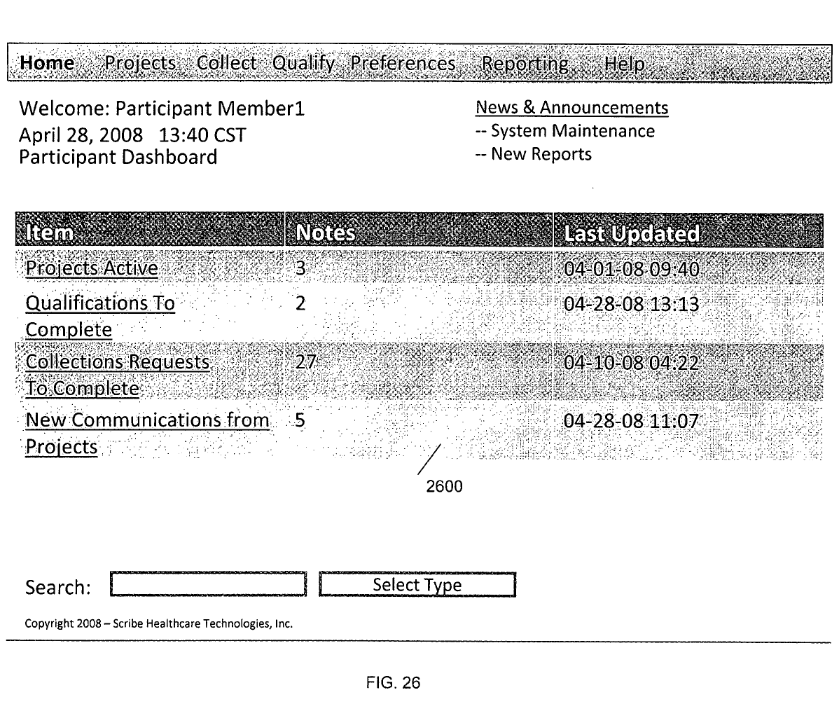

FIG. 26 is a diagram of a participant web site—home page. A participant may track her/his participation in projects in one page in a matrix 2600 and quickly and easily update, interact and communicate about information.

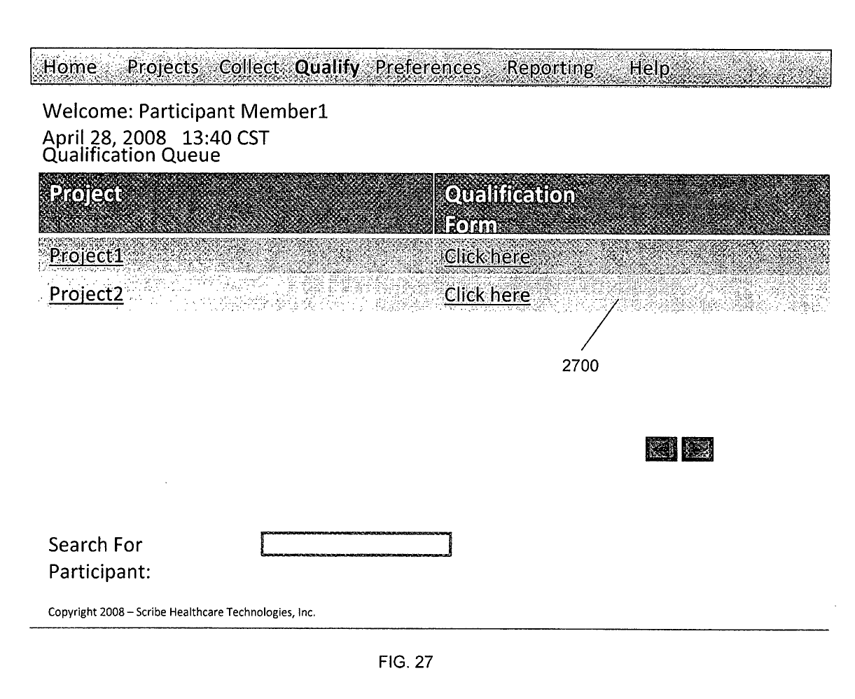

FIG. 27 is a diagram of a participant web site—qualification queue. This allows the participants to quickly complete qualifications and receive answers in real-time. Project and qualification information can be found in a matrix 2700 through hyperlinked terms.

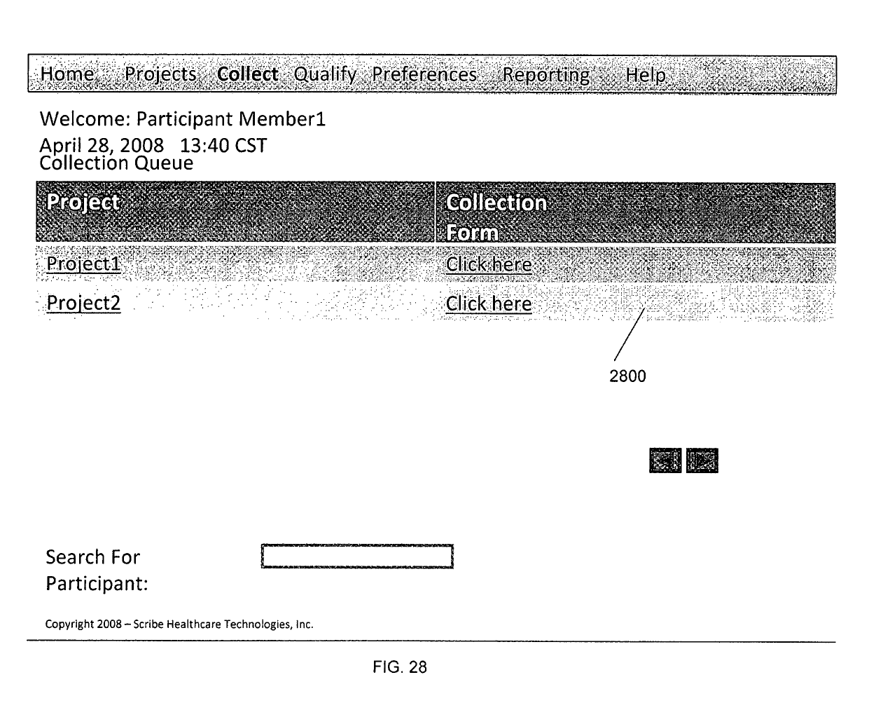

FIG. 28 is a diagram of a participant web site—collection queue. This web page provides a participant a quick and easy way to review ongoing information about the projects she/he is involved in. Information is accessible from a matrix 2800 by clicking on hyperlinked terms.

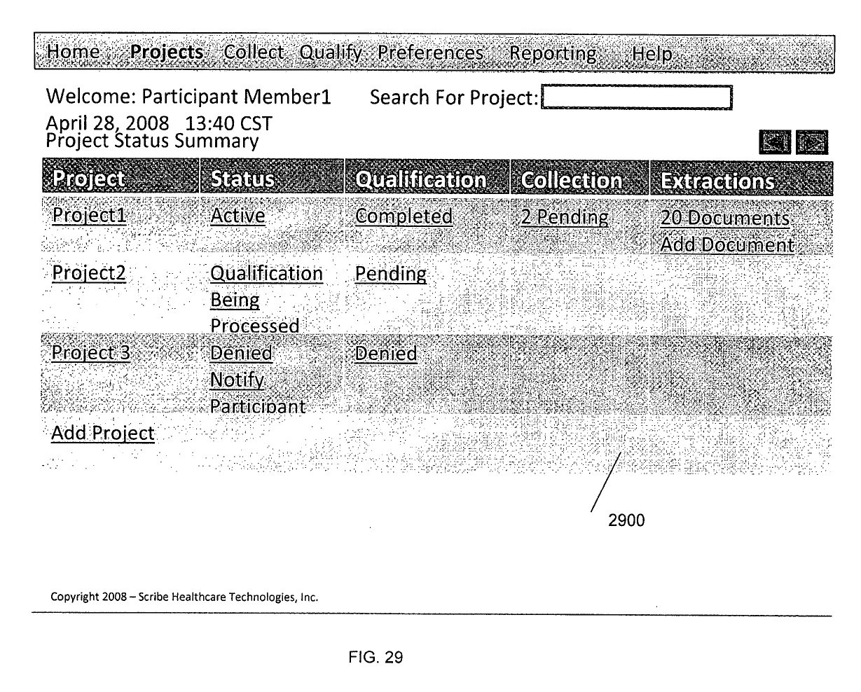

FIG. 29 is a diagram of a participant web site—project home page. This web page provides a simple overview of all projects a participant may be involved in and makes it easy for a participant to provide the information required and manage participation. It also shows a status of a qualification process for a project in matrix 2900.

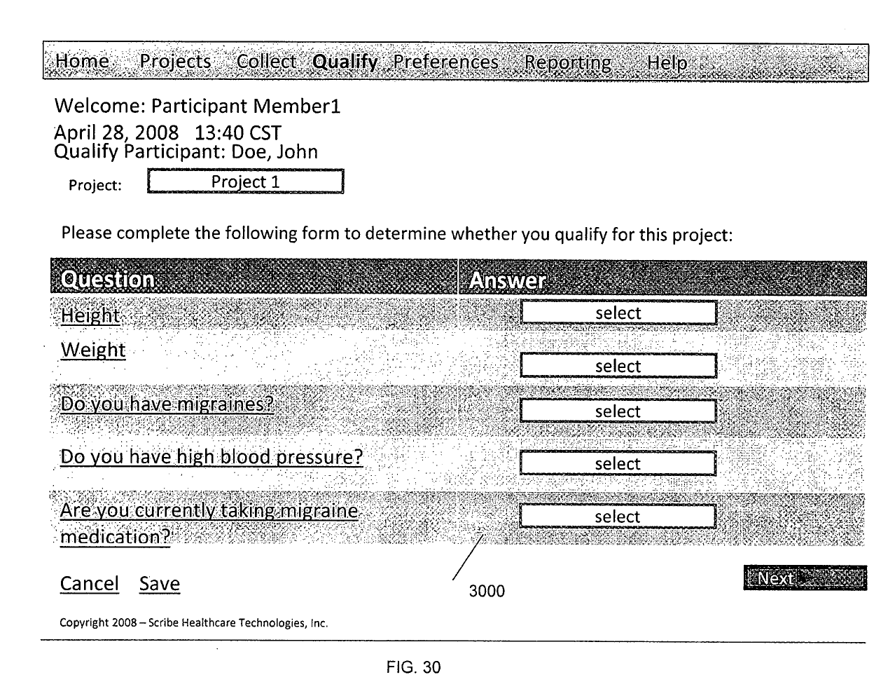

FIG. 30 is a diagram of a participant web site—qualification form. A participant can quickly and easily fill out qualification information requests in matrix 3000 and receive instant answers.

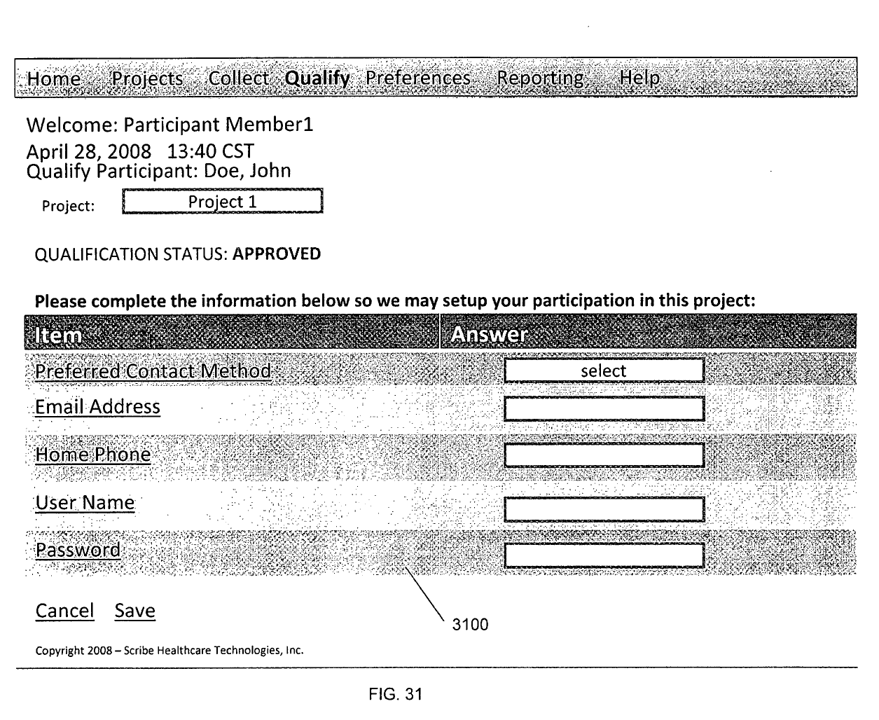

FIG. 31 is a diagram of a participant member web site—approved participation completion. It provides almost instantaneous feedback on approval (or rejection) in most cases. It also allows a participant to provide contact information in a matrix 3100.

As was shown before, all parties that participate in a clinical trial: network member, provider or participant, have access to information related to a project. Clearly, different parties may have different levels of access to information and are provided with different authority to enter, modify or delete data. All access to data or to applications may be provided through a computer based interface such as a web page. Access may also be provided through electronic messages which may not be displayed on a web page. A menu bar was shown in the diagram of the screen shots such as 1106 in FIG. 11. The following describes in some level of detail what kind of functionality is provided to a user by the menu.

The log-in name is related to as the role that a user has: network member, provider or participant. This determines the level of access.

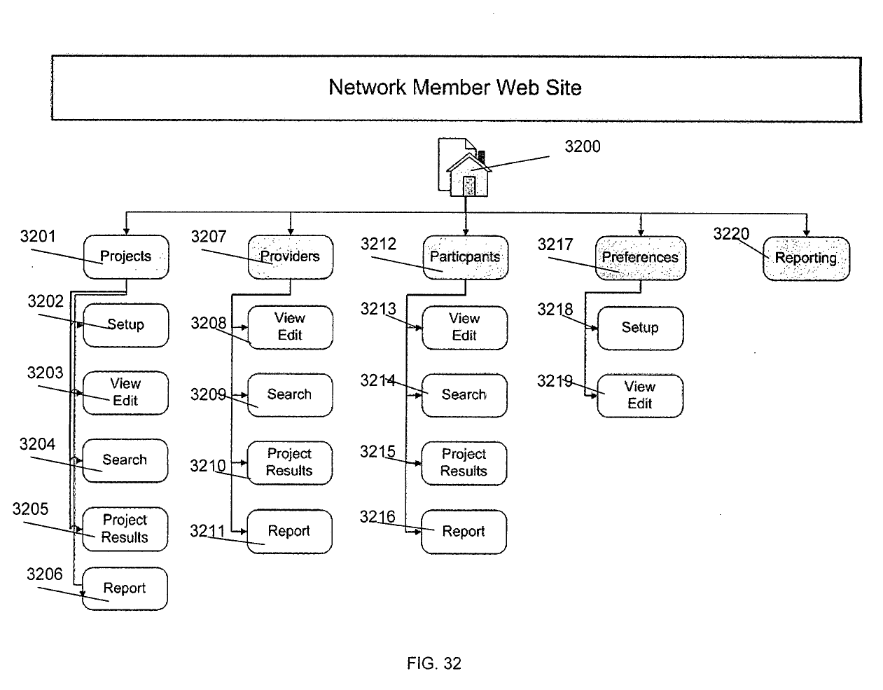

For instance, a network member may have authority to access as shown in FIG. 32. After signing on a network member enters a home page 3200 in FIG. 32 as shown in FIG. 11. From there, for instance by using a menu, a network member can access data and enter or change data. For instance, the signed on network member may access data and edit data related to projects 3201, providers 3207, participants 3212, preferences 3212 in presentation and interface for instance in 3217 and a reporting function 3220.

Each function represented by a numeral may be either a menu or a web page.

In projects, a network member may set-up a new project at 3202, view and edit existing projects at 3203, search for project information at 3204, review projects results at 3205, and generate and review reports at 3206.

A network member may review providers, view and edit provider information at 3208, search for provider information at 3209, review project results related to a provider at 3210 and provide reports at 3211.

A network member may review participants at 3212, view and edit participant information at 3213, search for participant information at 3214, review project results related to a participant at 3215 and provide reports at 3216.

In 3217 a network member may provide preferences for different functions such as contact information like address, phone, email, how they'd like to receive notifications, change their passwords, etc. wherein 3218 allows a user to set-up the preferences and 3219 to view and edit the preferences.

In 3218 a network member can setup their contact information, passwords, notification preferences among other items.

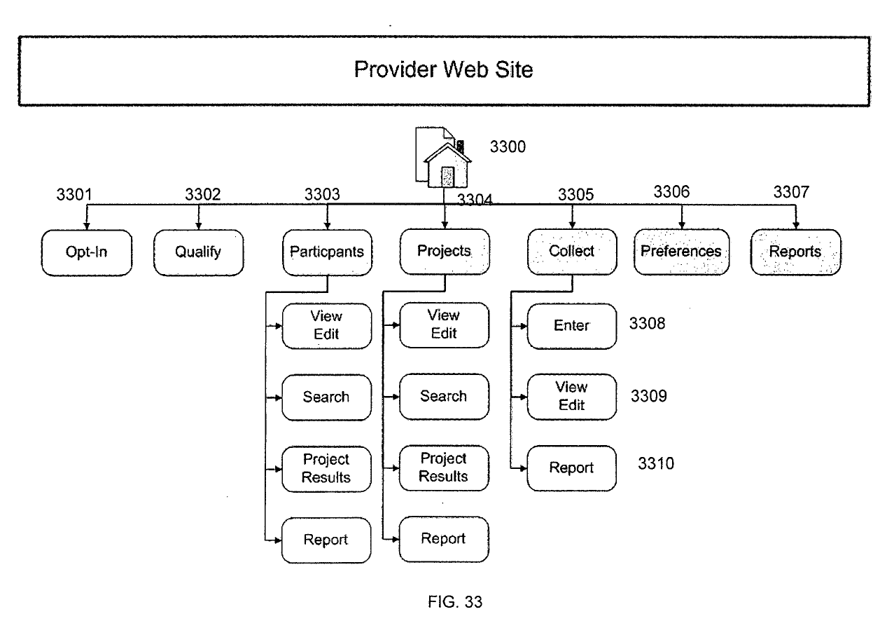

FIG. 33 provides an overview of possible web pages for a provider. The pages provided are opt-in 3301. Herein, a provider can sign-up to have his patient information scanned for qualified participants and thus become a provider to the network in a project. In 3202 a provider can qualify a participant for a project. In 3303 a provider can review and manage participants. The steps herein are like in the equivalent part in FIG. 32. The same applies for 3304 for reviewing projects. In 3305 a provider can review and edit the collection of data. This is equivalent to the page of FIG. 21. In 3308 a provider can enter information. In 3309 collection information can be viewed and in 3310 a reports can be generated. Preferences 3306 and report 3307 are similar to the ones in FIG. 32.

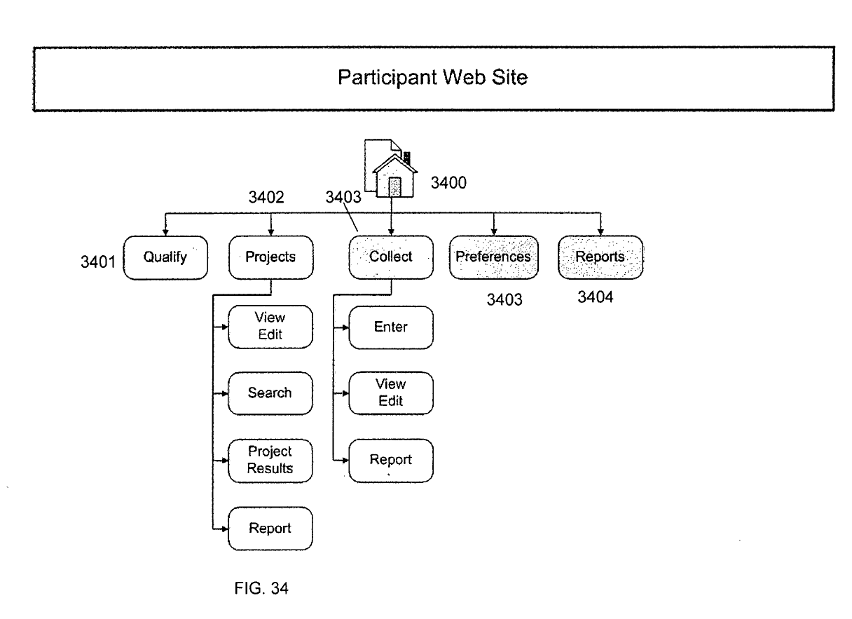

FIG. 34 provides an overview of possible web pages for a participant. A home page 3400 shows an overview for a participant, such as shown in FIG. 26. A qualify page 3401 is available which may be like the page shown in FIG. 27. An overview page for a collect function 3403 such as in FIG. 28 is provided. A project page 3402 may be like FIG. 29 may also be provided. Preferences and reports can be managed by a participant in 3403 and 3404.

It thus shows that a coherent set of tools are provided and implemented that enable participation, collaboration and sharing of information related to a clinical trial in one connected or networked system for clinical trial or medical research involving all participants in such a trial.

A patient may be identified as having a certain status in a project. In a pre-stage to a project a patient may have patient data in a medical database. That data may have limited access. For instance, access may be limited to a healthcare provider or a physician. A patient may be invited to join a network for clinical trial or medical research. A patient may for instance be invited by a physician or a healthcare provider to join a network. After the patient agrees to join a network, a set of data may be entered into, for instance, a computer or a database. This data provides relevant information related to future clinical trials and research. Such data may contain data related to age, gender, vitals, occupation, and other data. It may also contain data related to medical history, current symptoms, complaints, use of medication and any other data that may be used to identify a patient as a participant or candidate in a specific project. Such data may be specifically entered in a database. Such data may also be extracted from existing data in a database. The data may be updated with relevant information. No matter how the data is provided, such data may be considered as being available and may be marked as being available for processing for selecting participants in research or a trial.

A patient may have a status that depends on the participation of the patient. Initially a patient may be a candidate. This may mean that a patient has signed up to potentially participate in a clinical trial. Relevant data of the patient or candidate in stored and may be marked in a computing device and may be searched or processed for instance by applying a targeting or identifying rule. The patient, at this stage, may not be part of any project but is potentially available if the patient meets certain criteria. Such a patient may have the status of a candidate.

As was stated earlier, a clinical trial network may try to sign up or aggregate as many candidates as possible. When a project is started a network member may initiate an identifying rule that may provide a set of criteria for a candidate to be considered to participate in a project. A project may seek adults in an age group of 25 to 35, with normal blood pressure and cholesterol levels and no symptoms of heart trouble for a new drug for migraine. Clearly, a person of 71 years old with high blood pressure would not qualify. For example, processing marked data of 10,000 candidates may provide a group of 2,100 candidates that are identified as meeting the project criteria. These identified candidates may be called potential participants.

In a next step marked data may be further processed but also other more detailed data of a potential participant may be processed. Such other more detailed data may include an agreement by the potential participant to become a participant in the project. Such other more detailed data may also include other clinical data which was not part of the marked data but is available to be processed. The data may be processed by a qualifying rule. A participant meeting the criteria of a qualifying rule may become qualified and becomes a participant.

Patient, candidate, potential participant and participant data are usually stored on a computing device under the responsibility of a healthcare provider. Healthcare providers may be physicians, medical clinics, hospitals and even insurance companies if they can provide candidate data. Research and clinical trials may be conducted under request, guidance or management of outside organizations. Research and clinical trials in a clinical trial network may also be conducted by a healthcare provider. Outside organizations may include pharmaceutical companies, research institutions, government organizations, insurance companies and contract organizations. They may also include other parties that want to conduct medical research or clinical trials. These outside organizations may want to have access to a clinical trial network as disclosed herein and may become a network member. In accordance with an aspect of the present invention, healthcare providers who submit patients as candidates to a clinical trial network may make anonymous the patient as a candidate in the clinical trial network. In that case, each patient has an identifier which shields identity information (such as name and address) from a network member. A healthcare provider as another aspect of the present invention is able to connect an identifier with a specific patient.

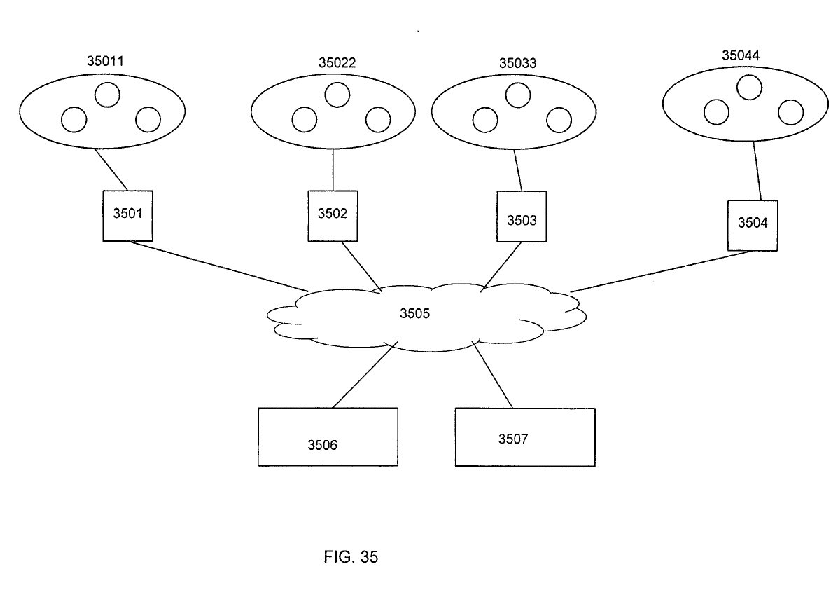

FIG. 35 provides a diagram of a clinical trial network in accordance with an aspect of the present invention. FIG. 35 shows as an illustrative example 4 healthcare providers 3501, 3502, 3503 and 3504. For instance, 3501 may be a hospital; 3502 may be a clinic; 3503 may be a physician or a group of physicians; and 3504 may be a group that has access to patient data for instance an insurance provider. Each provider has its own group of patients it has access to, indicated as 35011, 35022, 35033 and 35044. A healthcare provider may ask its patients to sign-up as a candidate for clinical trial. This means that patient data in a computing device may be available to a clinical trial network member, if required in anonymous form, for a candidate to be identified as a potential participant for a clinical trial. The data of a candidate may remain under control by the healthcare provider on a computing device. The computing device may be accessible for searching by a network member that wishes to create from a group of candidates a group of qualified participants.

For instance, a network member 3506 may want to identify potential participants and qualify participants as described earlier. A network member may have its own computing device to perform the methods described earlier as aspects of the present invention to identify and qualify. The network member may access the candidate data with a computing device that is connected to a network 3505 that may be the Internet. The computing devices holding candidate data are also connected to 3505.

One may, for instance, install the required computing devices and software to execute and perform the methods at a network member. A second network member 3507 may also have a computing device and software to identify and qualify candidates for a different clinical trial. Both 3506 and 3507 may have access to the same set of candidates aggregated from one or more healthcare providers.

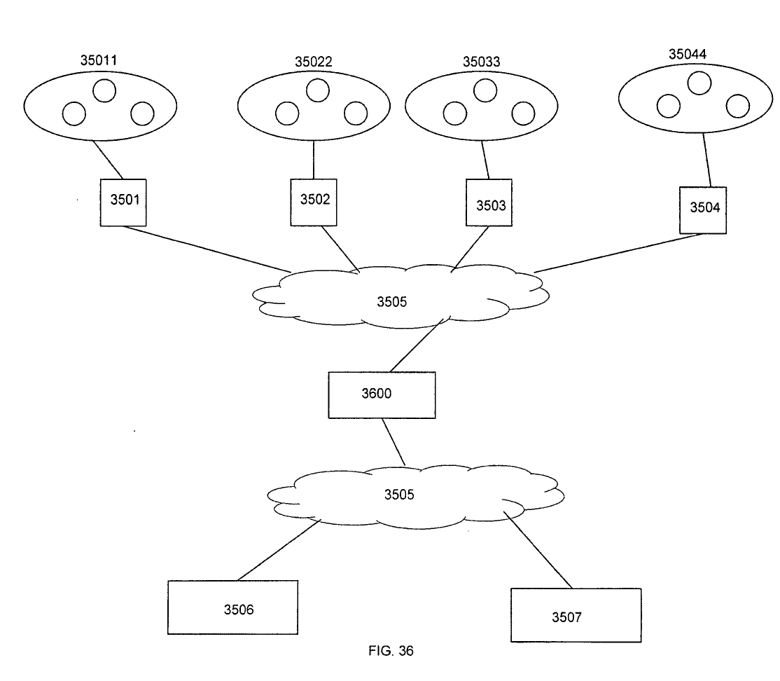

FIG. 36 shows a diagram provides a diagram of a clinical trial network in accordance with another aspect of the present invention. This diagram has all the elements of FIG. 35. In addition to those elements, the embodiment as shown in FIG. 36 has an operator/management unit 3600. For illustrative purposes the network 3505 is shown twice, but is still the same network. So, all parties, including 3600 and network members and healthcare providers are connected to the network 3505. FIG. 3600 illustrates that network members 3505 and 3506 may not have direct access to the candidate data in this embodiment, but have to use software installed at 3600. Such an embodiment may be helpful to protect and maintain the integrity of the clinical trial network and may also be helpful to ensure the protection of the privacy of patients. A clinical trial network may run multiple clinical trials at the same time. Applying a single or at least a limited number of organizations to access data may under certain conditions be to the benefit of candidates and to network members.

In summary, methods and systems have been provided as different aspects of the present invention that will setup a clinical trial project, including methods and systems for identifying and qualifying participants. Methods and systems for providing and using of rules, including databases to store the rules have also been provided. The automatic engagement of participants using data and rules stored in databases and computing devices to facilitate data exchange related to a trial have also been provided. This allows a network member to quickly start-up a project, identify and qualify participants, apply pre-set rules in a project, capture, extract, collect and distribute data from different sources and to review data related to one or more projects in an aggregated or an individual manner.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims appended hereto.

1. A method for conducting a clinical trial by using one or more rules which can be executed by a computing device for processing a set of clinical data of a patient, comprising:
engaging with a healthcare provider for making a set of data of the patient available on-line on an Internet;
identifying the patient as a potential participant by executing an identifying rule on the computing device; and
qualifying the patient as a participant by executing a qualifying rule on the computing device.

2. The method as claimed in claim 1, further comprising:
setting up the identifying rule in the computing device for identifying the patient as a potential participant from the set of data of the patient including applying one or more identifying parameters relevant to the clinical trial; and
setting up the qualifying rule in the computing device including applying one or more qualifying parameters relevant to the clinical trial.

3. The method as claimed in claim 1, further comprising:
setting-up of a collection rule for collecting in a computing device of the set of clinical data during the clinical trial.

4. The method as claimed in claim 3, further comprising:
automatically collecting of the set of clinical data via the Internet in accordance with the collection rule.

5. The method as claimed in claim 4, further comprising:
setting up of an extraction rule in a computing device for extracting a set of extracted data from the set of clinical data.

6. The method as claimed in claim 5, further comprising:
automatically extracting the set of extracted data from the set of clinical data in accordance with the extraction rule.

7. The method as claimed in claim 6, further comprising:
setting up of a distribution rule in a computing device for distributing of the set of extracted data to one or more predetermined recipients.

8. The method as claimed in claim 7, further comprising:
automatically distributing the set of extracted data extracted in accordance with the distribution rule.

9. A system for conducting a clinical trial, comprising:
a memory, the memory enabled to store and provide data;
a processor, the processor enabled to execute instructions retrieved from the memory to perform the steps of:
accessing a set of data of a patient via a network;
identifying the patient from the set of data of the patient as a potential participant by executing an identifying rule; and
qualifying the patient as a participant in the clinical trial by executing a qualifying rule.

10. The system as claimed in claim 9, wherein the network is an Internet.

11. The system as claimed in claim 9, further comprising the steps of:
receiving and storing the identifying rule including one or more identifying parameters relevant to the clinical trial; and
receiving and storing the qualifying rule including one or more qualifying parameters relevant to the clinical trial.

12. The system as claimed in claim 9, further comprising the steps of:
receiving and storing of a collection rule for collecting over a network of a set of clinical data of the patient after being qualified related to the clinical trial.

13. The system as claimed in claim 12, further comprising a step of:
automatically collecting of the set of clinical data of the patient via the network in accordance with the collection rule.

14. The system as claimed in claim 13, further comprising the steps of:
receiving and storing of an extraction rule for extracting a set of extracted data from the set of clinical data of the patient collected via the network.

15. The system as claimed in claim 14, further comprising a step of:
automatically extracting the set of extracted data from the set of clinical data of the patient collected via the network in accordance with the extraction rule.

16. The system as claimed in claim 15, further comprising the steps of:
receiving and storing of a distribution rule for distributing via a network of the set of extracted data to one or more predetermined recipients.

17. The system as claimed in claim 16, further comprising a step of:
automatically distributing the set of extracted data via the network to one or more predetermined recipients in accordance with the distribution rule.

18. The system as claimed in claim 9, wherein the set of data of the patient is made available by a healthcare provider.

19. A method for forming a clinical trial network, comprising:
signing-up a plurality of candidates from a plurality of patients at one or more health care providers for the clinical trial network;
for each of the plurality of candidates, making a data set related to the candidate available from one or more computing devices; and
applying a clinical trial identifying rule using a clinical trial computing device to search the data sets related to the candidates at the one or more computing devices to aggregate potential participants in a clinical trial.

20. The method as claimed in claim 19, wherein the data sets related to the plurality of candidates are made available over an Internet.
